(19) United States
(12) Patent Application Publication
(10) Pub. No.: US 2023/0031464 A1
(43) Pub. Date: Feb. 2, 2023

(54) IMAGE PROCESSING APPARATUS AND VIRTUAL ILLUMINATION SYSTEM

(71) Applicant: Panasonic Intellectual Property Management Co., Ltd., Osaka (JP)

(72) Inventors: Hiroki KASUGAI, Osaka (JP); Takashi SUZUKI, Osaka (JP); Yasuhiro SHINGU, Osaka (JP)

(21) Appl. No.: 17/876,836

(22) Filed: Jul. 29, 2022

(30) Foreign Application Priority Data
Aug. 2, 2021 (JP) 2021-126690
Mar. 16, 2022 (JP) 2022-041423

(51) Int. Cl. H04N 5/232; H04N 5/262; H04N 5/225; G06T 15/50

(52) U.S. Cl. CPC H04N 5/232935; H04N 5/2628; H04N 5/2256; H04N 5/23229; G06T 15/506; G06T 2200/24; G06T 2200/08

(57) ABSTRACT

An image processing apparatus includes: a first input interface that acquires first image data indicating an original image shot with an imaging device with respect to a subject in a shooting environment; a second input interface that acquires illuminance distribution information indicating a distribution based on illumination light radiated onto the subject from an illumination device in the shooting environment; a user interface that receives a user operation to set virtual illumination; and a controller that generates second image data by retouching the first image data to apply an illumination effect onto the original image with reference to the illuminance distribution information, the illumination effect corresponding to the virtual illumination set by the user operation.

### BACKGROUND

### 1. Technical Field

The present disclosure relates to an image processing apparatus that performs image processing on an illumination effect of an image to be shot, and a virtual illumination system.

### 2. Related Art

JP 2018-163648 A discloses an image processing apparatus intended to generate a natural image having a stereoscopic effect after correcting a high luminance region of an image. This image processing apparatus acquires normal line information corresponding to an image to be corrected based on distance image data, and estimates an actual illumination parameter based on a high luminance region of a subject included in the image. Furthermore, the image processing apparatus sets a virtual illumination parameter based on the estimated actual illumination parameter so that the angle formed by the orientation of the virtual illumination and the orientation of the actual illumination does not increase by a predetermined angle or more. Lighting processing is executed on the image based on the normal information and the virtual illumination parameter.

### SUMMARY

The present disclosure provides an image processing apparatus and a virtual illumination system capable of facilitating to realize an illumination effect according to an intention of a user on a shot image or a natural illumination effect in an image of a subject.

An image processing apparatus according to one aspect of the present disclosure includes: a first input interface that acquires first image data indicating an original image shot with an imaging device with respect to a subject in a shooting environment; a second input interface that acquires illuminance distribution information indicating a distribution based on illumination light radiated onto the subject from an illumination device in the shooting environment; a user interface that receives a user operation to set virtual illumination; and a controller that generates second image data by retouching the first image data to apply an illumination effect onto the original image with reference to the illuminance distribution information, the illumination effect corresponding to the virtual illumination set by the user operation.

An image processing apparatus according to another aspect of the present disclosure includes: a first input interface that acquires image data indicating an image of a subject; a second input interface that acquires illuminance distribution information indicating a distribution based on illumination light radiated onto the subject from a plurality of light source positions; and a controller that generates model information, based on the acquired image data and the acquired illuminance distribution information, the model information including the image of the subject and a characteristic for the subject to reflect light for each position in the image.

An image processing apparatus according to further another aspect of the present disclosure includes: a memory that stores model information including an image of a subject; a user interface that receives a user operation with respect to virtual illumination for the subject; a controller that controls simulation processing according to the user operation, the simulation processing calculating an illumination effect for the model information according to the virtual illumination to be set; and a display that displays an effected image to which the illumination effect is applied by the simulation processing, wherein the model information indicates a characteristic for the subject to reflect light for each position in the image of the subject, based on a distribution by illumination light radiated onto the subject from a plurality of light source positions, and wherein the controller performs the simulation processing to apply the illumination effect to the image of the subject, based on the characteristic of the subject indicated by the model information.

A virtual illumination system in the present disclosure includes an imaging device that captures an image of a subject and generates image data and/or an illumination device that irradiates the subject with illumination light and acquires information indicating a distribution by the illumination light, and any of the information processing apparatuses described above.

According to the image processing apparatus and the virtual illumination system in the present disclosure, it is possible to facilitate to realize the illumination effect according to the intention of the user on the shot image or the natural illumination effect in the image of the subject.

### BRIEF DESCRIPTION OF DRAWINGS

FIG. 1 is a diagram for explaining an imaging system according to a first embodiment of the present disclosure;

FIG. 2 is a diagram illustrating a configuration of a digital camera in the imaging system;

FIG. 3 is a diagram illustrating a configuration of an illumination device in the imaging system;

FIG. 4 is a front view illustrating a structure of the illumination device;

FIG. 5 is a diagram illustrating a configuration of a video editing PC in the imaging system;

FIG. 6 is a diagram illustrating a display example of an illumination editing screen in the imaging system;

FIG. 7 is a flowchart illustrating processing in the video editing PC of the imaging system;

FIG. 8 is a flowchart for explaining image processing of virtual illumination in the imaging system;

FIGS. 9A to 9C are diagrams illustrating illuminance distribution data by the illumination device of the imaging system;

FIG. 10 is a diagram for explaining an operation of the illumination device of the imaging system;

FIGS. 11A to 11C are diagrams illustrating a reflectance map in the image processing of virtual illumination;

FIGS. 12A and 12B are diagrams for explaining coordinate transformation in the image processing of virtual illumination;

FIG. 13 is a diagram for explaining calculation of an illumination effect in the image processing of virtual illumination;

FIG. 14 is a diagram for explaining a virtual illumination system according to a second embodiment of the present disclosure;

FIG. 15 is a flowchart illustrating an article imaging operation in the virtual illumination system;

FIG. 16 is a diagram illustrating an environment of the article imaging operation in the virtual illumination system;

FIG. 17 is a diagram illustrating a data structure of model information in the virtual illumination system;

FIG. 18 is a flowchart for explaining estimation processing of a reflection characteristic in the virtual illumination system;

FIG. 19 is a flowchart illustrating a background imaging operation in the virtual illumination system;

FIG. 20 is a diagram illustrating an environment of the background imaging operation in the virtual illumination system;

FIG. 21 is a flowchart illustrating arrangement simulation processing in the virtual illumination system;

FIG. 22 is a diagram illustrating a display example of the arrangement simulation processing in the virtual illumination system;

FIG. 23 is a flowchart illustrating a moving-image shooting operation in a virtual illumination system according to a third embodiment of the present disclosure;

FIGS. 24A and 24B are timing charts for explaining an operation example of exclusive control in the virtual illumination system;

FIG. 25 is a diagram illustrating first modification of the article imaging operation in the virtual illumination system; and

FIG. 26 is a diagram illustrating second modification of the article imaging operation in the virtual illumination system.

### DETAILED DESCRIPTION

Embodiments will be described in detail below with reference to the drawings as appropriate. However, more detailed description than necessary may be omitted. For example, detailed description of already well-known matters and redundant description of substantially the same configuration may be omitted. This is to avoid the following description from becoming unnecessary redundant and to facilitate understanding by those skilled in the art. In addition, the applicant(s) provides the accompanying drawings and the following description to enable those skilled in the art to sufficiently understand the present disclosure, which does not intend to limit the claimed subject matter.

### First Embodiment

In a first embodiment, an example in which an imaging system as an example of a virtual illumination system according to the present disclosure is applied to a video production site will be described.

### 1. Configuration

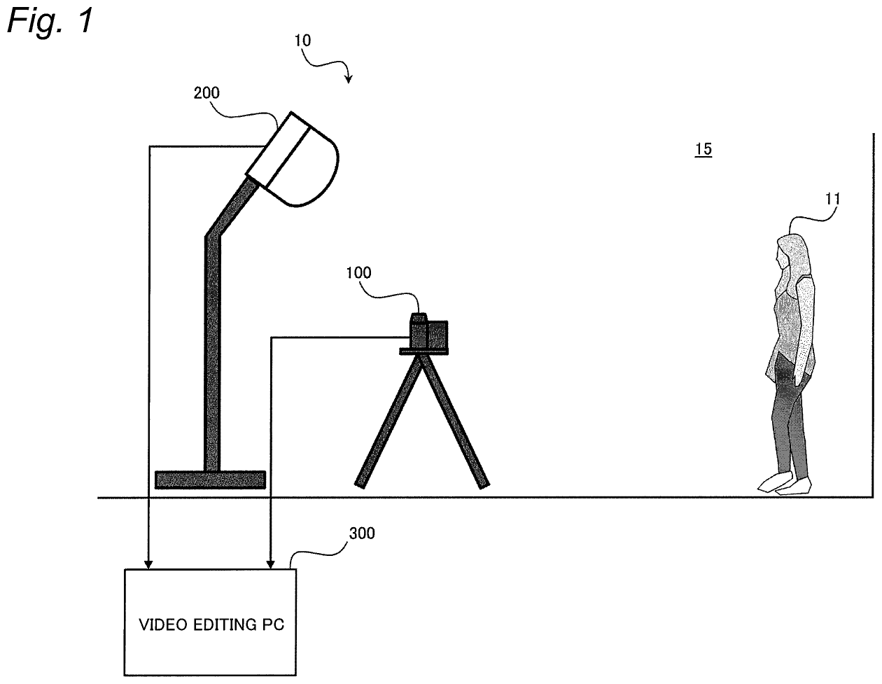

The imaging system according to the first embodiment of the present disclosure will be described with reference to FIG. 1.

As illustrated in FIG. 1, an imaging system 10 according to the present embodiment includes a digital camera 100, an illumination device 200, and an information terminal 300 as a video editing personal computer (PC), for example. The present system 10 is applicable for a user such as a creator to create various video images such as a moving image or a still image of a subject 11 in desired performance, for example. FIG. 1 illustrates an example in which the present system 10 is arranged at an image-shooting site 15 where the image of the subject 11 is shot in such a video production application.

Typically, in the image-shooting site 15 for video production, various types of illumination equipment are used in order to obtain an illumination effect for producing a desired atmosphere by a creator or the like and removing a shadow of the subject 11. In the conventional illumination technology, in order to obtain a desired illumination effect, preparation is needed such as obtaining appropriate illumination equipment and arranging the illumination equipment at an appropriate position before shooting a video. Such preparation requires an advanced expertise in illumination technology to perform it properly. For example, an inappropriate arrangement of the illumination equipment or the like causes rework such as re-shooting of the video. As such, it is difficult to realize video production with a high degree of freedom in terms of restriction of the illumination effect.

Therefore, the imaging system 10 according to the present embodiment uses the new illumination device 200 different from the conventional illumination equipment at the time of shooting a video with the digital camera 100, thereby making it possible to apply an illumination effect in the video editing PC 300 after shooting the video. According to the present system 10, it is possible to realize video production with a high degree of freedom such that a desired illumination effect can be edited in post-processing, without the need to prepare particularly difficult illumination equipment.

For example, as illustrated in FIG. 1, the present system 10 is used by arranging the digital camera 100 and the illumination device 200 at the image-shooting site 15. For example, in the arrangement example of FIG. 1, the digital camera 100 of the present system 10 is arranged at a position for shooting an image of the subject 11 at the image-shooting site 15.

In the image-shooting site 15, the illumination device 200 of the present system 10 is arranged at a position where illumination light can be irradiated in a wide range including a field angle range where an image is shot with the digital camera 100, for example. A user of the present system 10 can use the illumination device 200 without performing precise arrangement such as eliminating the shadow of the subject 11 as in the conventional illumination equipment in particular.

In the present system 10, some or all of the digital camera 100, the illumination device 200, and the video editing PC 300 may be connected to each other in a data-communicable manner by wired or wireless communication. For example, the digital camera 100 may synchronously control the operation of the illumination device 200, or may automatically transfer data such as an imaging result to the video editing PC 300. For example, the video editing PC 300 may not be particularly connected for communication. For example, the user may input various data obtained from the digital camera 100 or the like to the video editing PC 300 by using a portable storage medium.

Hereinafter, a configuration of each of the devices 100, 200, and 300 in the present system 10 will be described.

### 1-1. Configuration of Digital Camera

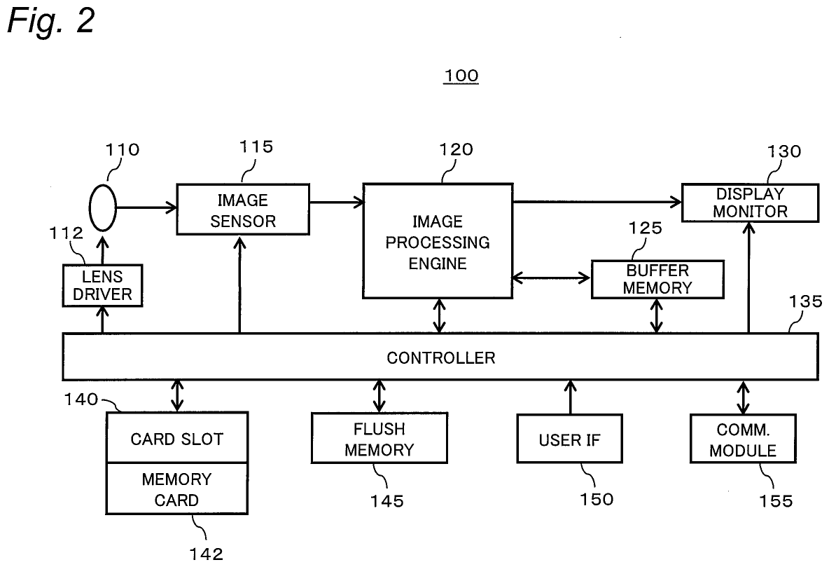

A configuration of the digital camera 100 in the present embodiment will be described with reference to FIG. 2.

FIG. 2 is a diagram illustrating the configuration of the digital camera 100 in the present system 10. The digital camera 100 is an example of an imaging device in the present embodiment. The digital camera 100 according to the present embodiment includes an image sensor 115, an image processing engine 120, a display monitor 130, and a controller 135. Further, the digital camera 100 includes a buffer memory 125, a card slot 140, a flash memory 145, a user interface 150, and a communication module 155. Furthermore, the digital camera 100 includes an optical system 110 and a lens driver 112, for example.

The optical system 110 includes a focus lens, a zoom lens, an optical image stabilizer (OIS), an aperture diaphragm, a shutter, and the like. The focus lens is a lens for changing a focus state of a subject image formed on the image sensor 115. The zoom lens is a lens for changing magnification of a subject image formed by the optical system. Each of the focus lens and the like includes one lens or more lenses.

The lens driver 112 drives the focus lens and the like in the optical system 110. The lens driver 112 includes a motor, to move the focus lens along the optical axis of the optical system 110 under the control of the controller 135. The configuration for driving the focus lens in the lens driver 112 can be realized by a DC motor, a stepping motor, a servo motor, an ultrasonic motor, or the like.

The image sensor 115 captures a subject image formed via the optical system 110 to generate imaging data. The imaging data constitutes image data indicating an image captured by the image sensor 115. The image sensor 115 generates image data of a new frame at a predetermined frame rate (e.g., 30 frames/second). The generation timing of the imaging data and an electronic shutter operation in the image sensor 115 are controlled by the controller 135. As the image sensor 115, various image sensors such as a CMOS image sensor, a CCD image sensor, or an NMOS image sensor can be used.

The image sensor 115 performs an operation of capturing a still image, an operation of capturing a through image, and the like. The through image is mainly a moving image, and is displayed on the display monitor 130 in order for the user to determine a composition for capturing a still image. Each of the through image and the still image is an example of a captured image in the present embodiment. The image sensor 115 is an example of an imager in the present embodiment.

The image processing engine 120 performs various processing on the imaging data output from the image sensor 115 to generate image data, and performs various processing on the image data to generate an image to be displayed on the display monitor 130. Examples of various processing include white balance correction, gamma correction, YC conversion processing, electronic zoom processing, compression processing, expansion processing, and the like, but the various processing are not limited thereto. The image processing engine 120 may be configured by a hard-wired electronic circuit, or may be configured by a microcomputer using a program, a processor, or the like.

The display monitor 130 is an example of display that displays various information. For example, the display monitor 130 displays an image (through image) indicated by image data captured by the image sensor 115 and subjected to image processing by the image processing engine 120. In addition, the display monitor 130 displays a menu screen or the like for the user to perform various settings on the digital camera 100. The display monitor 130 can be configured by, for example, a liquid crystal display device or an organic EL device.

The user interface 150 is a general term for hard keys such as operation buttons and operation levers provided on the exterior of the digital camera 100, operable to receive an operation by the user. For example, the user interface 150 includes a release button, a mode dial, and a touch panel. When the user interface 150 receives an operation by the user, the user interface 150 transmits an operation signal corresponding to the user operation to the controller 135.

The controller 135 integrally controls the entire operation of the digital camera 100. The controller 135 includes a CPU and the like, and the CPU executes a program (software) to realize a predetermined function. The controller 135 may include, instead of the CPU, a processor including a dedicated electronic circuit designed to realize a predetermined function. That is, the controller 135 can be realized by various processors such as a CPU, an MPU, a GPU, a DSP, an FPGA, and an ASIC. The controller 135 may include one or more processors. The controller 135 may include one semiconductor chip together with the image processing engine 120 and the like.

The buffer memory 125 is a recording medium that functions as a work memory of the image processing engine 120 and the controller 135. The buffer memory 125 is realized by a dynamic random access memory (DRAM) or the like. The flash memory 145 is a nonvolatile recording medium. Furthermore, although not illustrated, the controller 135 may include various internal memories, and may incorporate a ROM, for example. The ROM stores various programs to be executed by the controller 135. Furthermore, the controller 135 may incorporate a RAM that functions as a work area of the CPU.

The card slot 140 is a module into which a removable memory card 142 is inserted. The memory card 142 can be connected to the card slot 140 electrically and mechanically. The memory card 142 is an external memory including a recording element such as a flash memory therein. The memory card 142 can store data such as image data generated by the image processing engine 120.

The communication module 155 is a module (circuit) that connects to an external device according to a predetermined communication standard in wired or wireless communication. For example, the predetermined communication standard includes USB, HDMI (registered trademark), IEEE 802.11, Wi-Fi, Bluetooth, and the like. The digital camera 100 can communicate with other devices via the communication module 155.

### 1-2. Configuration of Illumination Device

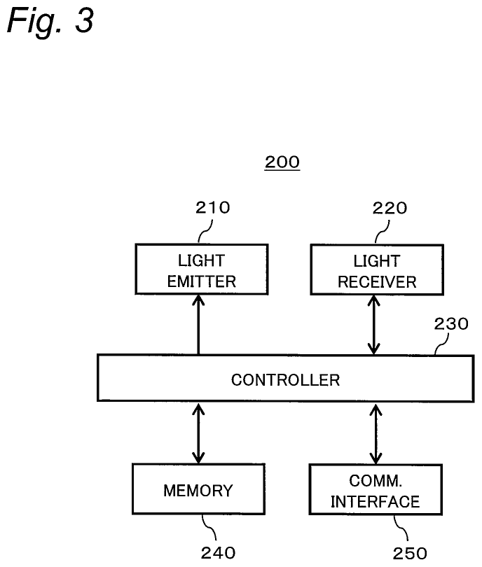

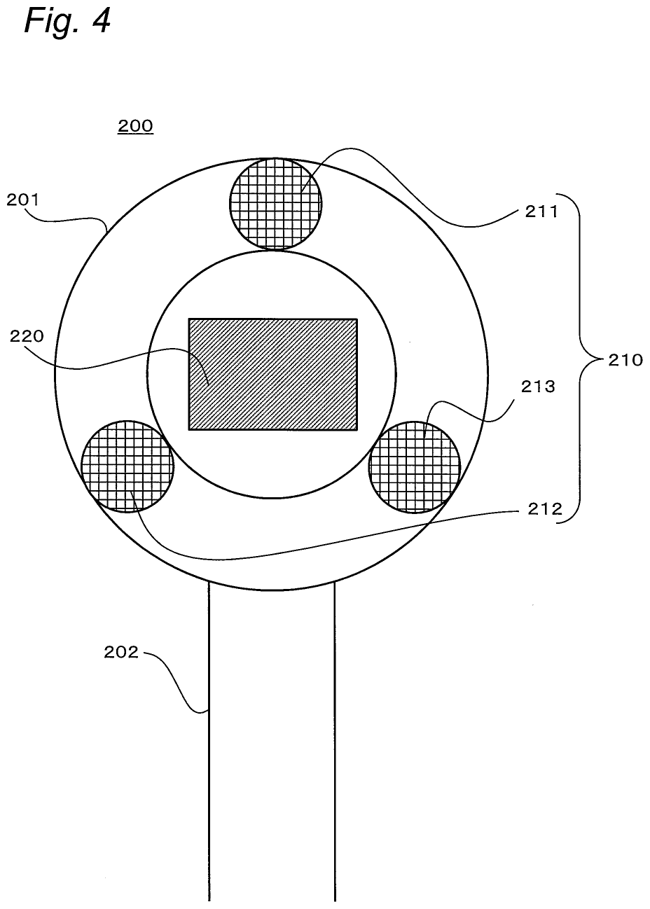

A configuration of the illumination device 200 in the present embodiment will be described with reference to FIGS. 3 to 4.

FIG. 3 is a diagram illustrating the configuration of the illumination device 200 in the present system 10. For example, as illustrated in FIG. 3, the illumination device 200 includes a light emitter 210, a light receiver 220, a controller 230, a memory 240, and a communication interface 250. The structure of the illumination device 200 is illustrated in FIG. 4.

FIG. 4 illustrates a front view of a head portion 201 in the illumination device 200 as viewed from a direction in which illumination light is emitted. The head portion 201 is a portion in which the light emitter 210 and the light receiver 220 are assembled in the illumination device 200. The illumination device 200 further includes an arm portion 202 that supports the head portion 201, for example.

In the illumination device 200, the light emitter 210 includes various light source devices so as to emit illumination light having various wavelengths in a visible region, for example. For example, the light emitter 210 includes a plurality of illumination light sources 211 to 213 as illustrated in FIG. 4. FIG. 4 illustrates an example in which the light emitter 210 includes three illumination light sources 211 to 213. The light emitter 210 of the illumination device 200 is not limited thereto, and may include four or more illumination light sources 211 to 213, for example. Hereinafter, the illumination light sources 211 to 213 are collectively referred to as illumination light sources 21.

For example, the illumination light sources 21 are wavelength-tunable LEDs, to emit illumination light of a plurality of colors such as RGB at a predetermined light distribution angle. Each of the illumination light sources 21 may include monochromatic LEDs of a plurality of colors. The light distribution angle of the illumination light source 21 is set such that illumination light is radiated onto a spatial range including the subject 11 at the image-shooting site 15, for example. The illumination light sources 21 are able to emit the illumination light having the same wavelength. The light emitter 210 may emit white light as illumination light from the illumination light source 21.

For example, the first to third illumination light sources 211 to 213 in the light emitter 210 are arranged so as to surround the periphery of the light receiver 220 in the head portion 201. With such an arrangement, the light emitter 210 has light source positions different from each other in the first to third illumination light sources 211 to 213. The first to third illumination light sources 211 to 213 are arranged in orientations in which illumination light is radiated onto a common spatial range.

The light receiver 220 has a light receiving surface configured to be receivable of light in the visible region corresponding to the illumination light of the light emitter 210. The light receiver 220 includes various imaging elements such as a CCD image sensor, a CMOS image sensor, or an NMOS image sensor. For example, the light receiver 220 captures a monochrome image to generate data indicating a spatial distribution of illuminance as a light reception result. The light receiver 220 is not limited to monochrome, and may include a color filter such as RGB. The light receiver 220 may output data of an image of each color as a light reception result of each color light.

The controller 230 controls the entire operation of the illumination device 200, for example. The controller 230 includes a CPU or an MPU that realizes a predetermined function in cooperation with software, for example. The controller 230 may be a hardware circuit such as a dedicated electronic circuit or a reconfigurable electronic circuit designed to realize a predetermined function. The controller 230 may include various semiconductor integrated circuits such as a CPU, an MPU, a microcomputer, a DSP, an FPGA, and an ASIC.

The memory 240 includes a ROM and a RAM that store programs and data necessary for realizing the functions of the illumination device 200. For example, the memory 240 stores information indicating a positional relation between each of the illumination light sources 211 to 213 and the light receiver 220.

The communication interface 250 is a module (circuit) that connects to an external device according to a predetermined communication standard in wired or wireless communication. For example, the predetermined communication standard includes USB, HDMI, IEEE 802.11, Wi-Fi, Bluetooth, and the like.

### 1-3. Configuration of Video Editing PC

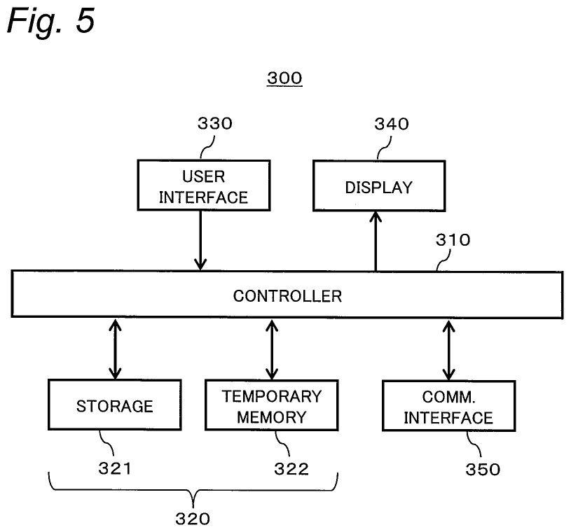

A configuration of the video editing PC 300 in the present embodiment will be described with reference to FIG. 5.

FIG. 5 is a diagram illustrating the configuration of the video editing PC 300. The video editing PC 300 is an example of an image processing apparatus including a personal computer. The video editing PC 300 illustrated in FIG. 5 includes a controller 310, a memory 320, a user interface 330, a display 340, and a communication interface 350.

The controller 310 includes a CPU or an MPU that realizes a predetermined function in cooperation with software, for example. The controller 310 controls the entire operation of the video editing PC 300, for example. The controller 310 reads data and programs stored in the memory 320 and performs various calculation processing to realize various functions.

For example, the controller 310 executes a program including a command group for realizing each of the above-described functions. The above program may be provided from a communication network such as the Internet, or may be stored in a portable recording medium. Furthermore, the controller 310 may be a hardware circuit such as a dedicated electronic circuit or a reconfigurable electronic circuit designed to realize each of the above-described functions. The controller 310 may include various semiconductor integrated circuits such as a CPU, an MPU, a GPU, a GPGPU, a TPU, a microcomputer, a DSP, an FPGA, and an ASIC.

The memory 320 is a storage medium that stores programs and data necessary for realizing the function of the video editing PC 300. As illustrated in FIG. 5, the memory 320 includes a storage 321 and a temporary memory 322.

The storage 321 stores parameters, data, control programs, and the like for realizing a predetermined function. The storage 321 includes, for example, an HDD or an SSD. For example, the storage 321 stores the above-described programs, various image data, and the like.

The temporary memory 322 includes a RAM such as a DRAM or an SRAM, to temporarily store (i.e., hold) data, for example. For example, the temporary memory 322 holds image data in the middle of being edited. In addition, the temporary memory 322 may function as a work area of the controller 310, and may be configured by a storage area in an internal memory of the controller 310.

The user interface 330 is a general term for operation members operated by a user. For example, the user interface 330 may be a keyboard, a mouse, a touch pad, a touch panel, a button, a switch, or the like. The user interface 330 also includes various GUIs such as virtual buttons, icons, cursors, and objects displayed on the display 340.

The display 340 is an example of an output interface including a liquid crystal display or an organic EL display, for example. The display 340 may display various information such as various GUIs for operating the user interface 330 and information input from the user interface 330.

The communication interface 350 is a module (circuit) that connects to an external device according to a predetermined communication standard in wired or wireless communication. For example, the predetermined communication standard includes USB, HDMI, IEEE 802.11, Wi-Fi, Bluetooth, and the like. The communication interface 350 may connect the video editing PC 300 to a communication network such as the Internet. The communication interface 350 is an example of an input interface that receives various information from an external device or a communication network.

The configuration of the video editing PC 300 as described above is an example, and the configuration of the video editing PC 300 is not limited thereto. For example, the input interface in the video editing PC 300 may be realized by cooperation with various software in the controller 310 or the like. The input unit in the video editing PC 300 may acquire various information by reading various information stored in various storage media (e.g., the storage 321) to a work area (e.g., the temporary memory 322) of the controller 310.

Furthermore, various display devices such as a projector and a head mounted display may be used for the display 340 of the video editing PC 300. Furthermore, in an exemplary case where an external display device is used, the display 340 of the video editing PC 300 may be an output interface circuit of a video signal or the like conforming to the HDMI standard or the like, for example.

### 2. Operation

The operation of the imaging system 10 configured as described above will be described below.

In the present system 10, for example, when the user shoots the video of the subject 11 with the digital camera 100 at the image-shooting site 15, the illumination device 200 acquires illuminance distribution data indicating the spatial distribution of the illuminance at the image-shooting site 15 including the subject 11.

For example, the digital camera 100 captures the video of the subject 11 at the image-shooting site 15 according to an operation of the user, to generate image data as an imaging result. In addition, the illumination device 200 causes the first to third illumination light sources 211 to 213 to emit light in order in the light emitter 210, and receives the reflected light of each of the illumination light sources 211 to 213 in time division in the light receiver 220, to generate illuminance distribution data for each illumination light source 21.

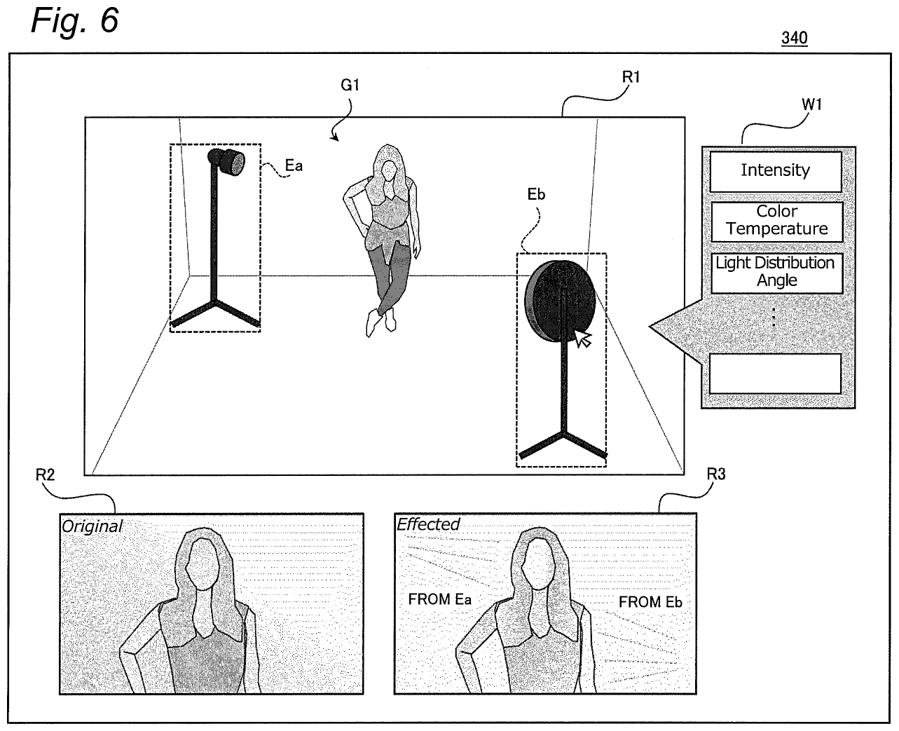

For example, the video editing PC 300 of the present system 10 inputs the illuminance distribution data together with the image data of the imaging result as described above, to execute post-processing for editing an illumination effect of the image data according to a user operation for setting virtual illumination. A display example in the display 340 of the video editing PC 300 is illustrated in FIG. 6.

FIG. 6 illustrates a display example of an illumination editing screen in the present system 10. For example, the illumination editing screen displayed on the display 340 of the video editing PC 300 includes a virtual illumination setting region R1, an original image region R2, and a retouched image region R3.

The virtual illumination setting region R1 is a region that enables input of an operation for the user to set desired virtual illumination. In the virtual illumination setting region R1 illustrated in FIG. 6, virtual illumination equipment Ea and Eb are arranged on an environment image G1 according to the user operation. The environment image G1 indicates the image-shooting site 15 in a wide range including the field angle range of the digital camera 100, for example.

The original image region R2 is a region where an image captured by the digital camera 100 is displayed as an original image to be edited. The retouched image region R3 is a region where an image in which the retouched image is displayed with the illumination effect by the virtual illumination equipment Ea and Eb set in the virtual illumination setting region R1 being reflected in the original image. Each of the image regions R2 and R3 can display a moving image, for example.

In the illumination editing screen, in response to input of the user operation to the virtual illumination setting region R1, an illumination effect corresponding thereto can be viewed as a change between the original image region R2 and the retouched image region R3. The user of the present system 10 can easily obtain a desired illumination effect by checking the image regions R2 and R3 while adjusting the arrangement of the virtual illumination equipment Ea and Eb on the environment image G1 of the image-shooting site 15, for example.

In the post-processing of editing as described above, the present system 10 can reproduce the illumination effect of the virtual illumination precisely on the image data of the actual imaging result, by using the illuminance distribution data obtained by the illumination device 200 of the image-shooting site 15. Details of the operation of the present system 10 will be described below.

### 2-1. Details of Operation

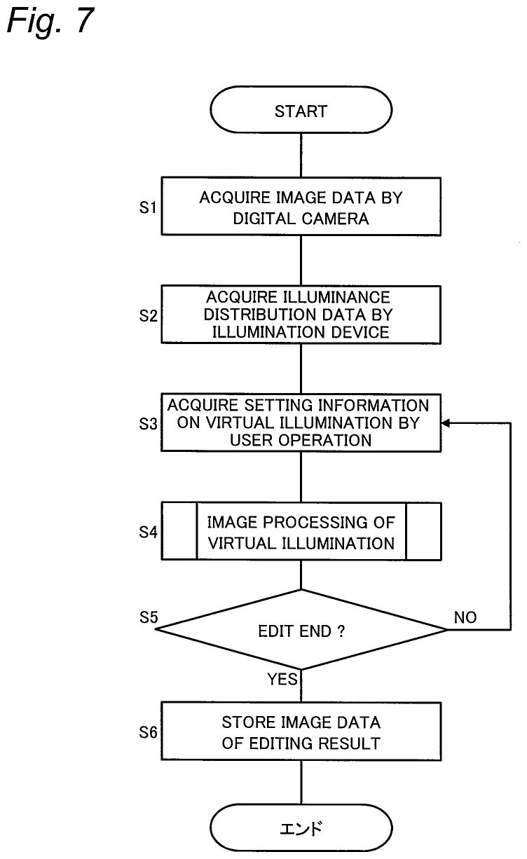

An operation of obtaining an illumination effect of virtual illumination in the present system 10 will be described with reference to FIG. 7.

FIG. 7 is a flowchart illustrating processing in the video editing PC 300 of the present system 10. Each processing illustrated in the flowchart of FIG. 7 is executed by the controller 310 of the video editing PC 300 after imaging at the image-shooting site 15, for example.

At first, the controller 310 of the video editing PC 300 acquires image data of an imaging result generated by the digital camera 100 from the digital camera 100 through data communication by the communication interface 350, for example (S1). The image data of the imaging result of the digital camera 100 may be acquired via another device, for example, a storage medium such as a memory card.

Furthermore, the controller 310 acquires illuminance distribution data generated by the illumination device 200 from the illumination device 200 via data communication by the communication interface 350, for example (S2). For example, at the shooting of a still image, the controller 230 of the illumination device 200 operates to generate illuminance distribution data before capturing an image by the digital camera 100. The illuminance distribution data is generated for each color such as RGB. For example, the illumination device 200 sequentially emits illumination light for each color from each illumination light source 21.

The operation of the illumination device 200 as described above may be performed before or after imaging to such an extent that the subject 11 and its environment at the image-shooting site 15 do not particularly change with an appropriate allowable error. Furthermore, the operation of the illumination device 200 may be controlled from the outside by the digital camera 100 or the like. In addition, the illuminance distribution data may be received by the digital camera 100 through data communication with the illumination device 200 and managed together with the corresponding image data. The video editing PC 300 may acquire the illuminance distribution data by the illumination device 200 through other various devices.

Furthermore, in a case where a moving image is shot with the digital camera 100, the operation of the illumination device 200 is performed by synchronization control with the operation of the digital camera 100 during the shooting of the moving image, for example. For example, an exposure period (e.g., several tens of ms) for image capturing by the digital camera 100 for each frame and an exposure period (e.g., several tens of ms) for illuminance information acquisition may be exclusively controlled. Alternatively, by using a TOF sensor or the like in combination, illuminance distribution data for each time may be generated so as to once acquire illuminance distribution data and then estimate a subsequent dynamic change.

For example, the controller 310 causes the display 340 to display the illumination editing screen (FIG. 6), based on the various data acquired as described above, and acquires setting information indicating various settings of the virtual illumination according to a user operation on the illumination editing screen in the user interface 330 (S3).

For example, in step S3, the controller 310 causes the image data (S1) acquired as the imaging result of the digital camera 100 to display as the original image in the original image region R2 on the illumination editing screen. In addition, the controller 310 generates the environment image G1, based on the illuminance distribution data (S2) acquired as the light reception result of the illumination device 200, to display the environment image G1 in the virtual illumination setting region R1. The controller 310 causes the user interface 330 to receive various user operations on displayed the illumination editing screen as the above. Before the input of the user operation, the retouched image region R3 may display the same original image as the original image region R2, or may be blank.

For example, in step S3, the controller 310 receives a user operation of setting arrangement such as positions and orientations of the virtual illumination equipment Ea and Eb on the environment image G1 indicating the image-shooting site 15 in the virtual illumination setting region R1. By the wide-angle environment image G1, the arrangement of such virtual illumination equipment Ea and Eb can be easily adjusted even outside the range of the original image (and the retouched image), for example.

In step S3, a user operation for increasing or decreasing the number of virtual illumination equipment Ea and Eb or adjusting setting parameters of the individual illumination equipment Ea and Eb can also be input. In the example of FIG. 6, a setting parameter input field W1 for the virtual illumination equipment Ea is displayed. For example, the setting parameters include intensity, color temperature, and light distribution angle of the illumination light. The controller 310 acquires the arrangement and setting parameters of the illumination equipment Ea and Eb as the setting information of the virtual illumination according to various user operations as described above (S3).

Next, the controller 310 performs image processing to apply the illumination effect of the virtual illumination to the original image, based on the image data, the illuminance distribution data, and the setting information of the virtual illumination acquired as described above (S4). The image processing of virtual illumination (S4) retouches the actually captured original image, based on the difference between the illuminance distributions of the image-shooting site 15 with respect to the different light source positions indicated by the illuminance distribution data by the illumination device 200. Then, a retouched image having the illumination effect of the virtual illumination according to the user operation is obtained. Details of the image processing of virtual illumination (S4) will be described later.

For example, responding to various user operations with the retouched image as a result of the image processing of virtual illumination (S4) being displayed in the retouched image region R3 on the illumination editing screen, the controller 310 determines whether or not an editing end operation is input, for example (S5). For example, when the user operates the virtual illumination setting region R1 so as to change various settings of the virtual illumination equipment Ea and Eb, the controller 310 proceeds to NO in step S5, and performs the processing of step S3 and subsequent steps again according to the changed setting of the virtual illumination.

For example, when the editing end operation is input (YES in S5), the controller 310 stores image data indicating the retouched image finally obtained by the image processing of virtual illumination (S4) in the memory 320 as the editing result (S6).

For example, the controller 310 ends the processing illustrated in the flowchart of FIG. 7 by recording the edited image data (S6).

According to the above operation of the present system 10, by using the illuminance distribution of the subject 11 at the image-shooting site 15 acquired at the time of imaging, adjustable post-processing can be realized while allowing the user to confirm the illumination effect of the virtual illumination afterwards in the video editing PC 300.

### 2-2. Image Processing of Virtual Illumination

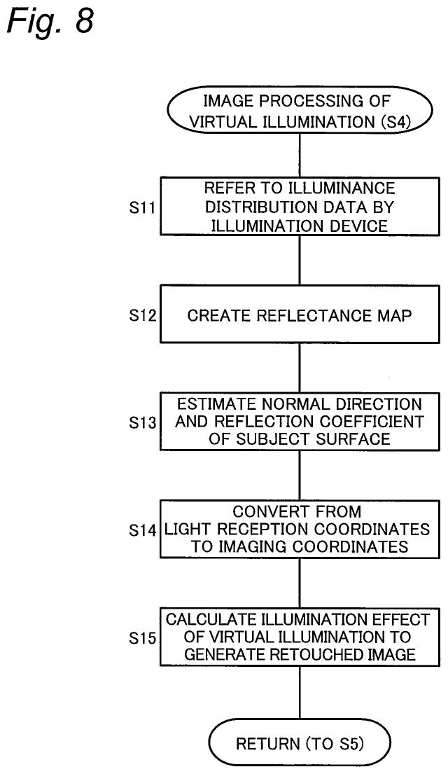

The image processing of virtual illumination in step S4 of FIG. 7 will be described with reference to FIGS. 8 to 13. FIG. 8 is a flowchart for explaining image processing (S4) of virtual illumination in the present system 10.

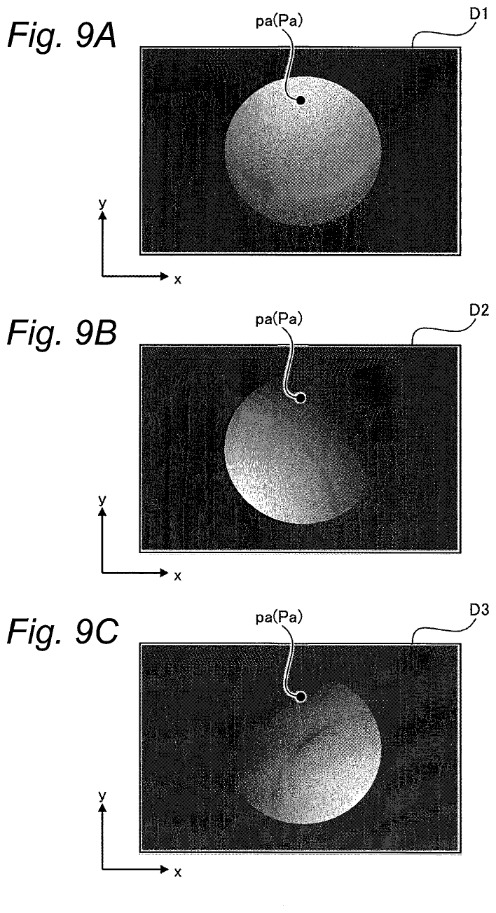

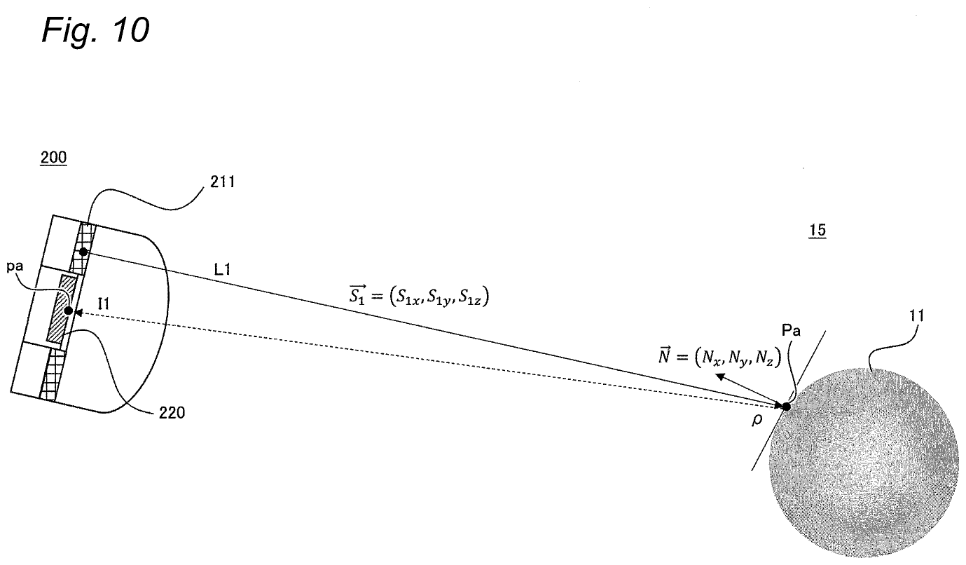

At first, the controller 310 of the present system 10 refers to the illuminance distribution data acquired in step S2 of FIG. 7 (S11). The illuminance distribution data is generated by the illumination device 200 of the present system 10 at the image-shooting site 15, for example. FIGS. 9A to 9C illustrate illuminance distribution data D1 to D3 by the illumination device 200 of the present system 10. FIG. 10 is a diagram for explaining the operation of the illumination device 200 when generating the illuminance distribution data D1 of FIGS. 9A to 9C.

FIG. 10 illustrates an example of the optical path of the illumination light emitted by the illumination device 200 at the image-shooting site 15. In the example of FIG. 10, the illumination light emitted from the first illumination light source 211 in the light emitter 210 with a light intensity L1 travels in a light beam direction S₁ and is reflected at a surface position Pa of the subject 11. The reflected light of the illumination light is observed at a light receiving position pa in the light receiver 220 at an illuminance I depending on a normal direction N and a reflection coefficient ρ of the surface position Pa of the subject 11.

The light beam direction S₁ and the normal direction N are each represented by a unit vector in a three-dimensional space. In the drawing, arrows representing vectors are attached thereto. For example, the light beam direction S₁ is set in advance for each illumination light source 21, and has a known set value. The normal direction N and the reflection coefficient ρ for each surface position Pa of the subject 11 are unknown estimation targets. For example, the illumination device 200 of the present embodiment acquires an illuminance I1 of the reflected light of the illumination light from the first illumination light source 211 for each light receiving position pa, to generate the illuminance distribution data D1 indicating the distribution of the illuminance I1 in the entire light receiving surface of the light receiver 220.

FIG. 9A illustrates the illuminance distribution data D1 of the light reception result according to the light emission of the first illumination light source 211. FIG. 9B illustrates the illuminance distribution data D2 according to the light emission of the second illumination light source 212. FIG. 9C illustrates the illuminance distribution data D3 according to the light emission of the third illumination light source 213. In FIGS. 9A to 9C, the magnitude of the illuminance is shown by shading so that the larger the illuminance, the lighter the gray.

The illuminance distribution data D1 illustrated in FIG. 9A indicates an illuminance distribution of reflected light obtained by reflecting the illumination light from the first illumination light source 211 at various surface positions Pa in the subject 11 over a spatial range that can be observed by the light receiver 220 under the environment of the image-shooting site 15. In such illuminance distribution, the illuminance at each surface position Pa of the subject 11 is distributed to the corresponding light receiving position pa in a light reception coordinates (x, y), that is, the coordinate system on the light receiving surface of the light receiver 220 of the illumination device 200.

In the illuminance distribution data D2 of FIG. 9B, an illuminance distribution different from that of FIG. 9A is obtained, with a space range of the same environment as FIG. 9A being illuminated by the second illumination light source 212 instead of the first illumination light source 211. For example, the illuminance observed at the same light receiving position pa in FIGS. 9A to 9C is different from each other according to the normal direction N and the reflection coefficient ρ of the surface position Pa of the corresponding subject 11.

The present system 10 estimates the normal direction N and the reflection coefficient ρ of each surface position Pa of the subject 11 at the image-shooting site 15 by analyzing the difference between the illuminance distribution data D1 to D3 with the plurality of illumination light sources 211 to 213 on the basis of an photometric stereo method, for example. Note that the normal direction N has two variables of freedom as an estimation target based on a unit vector normalization condition for a three-dimensional vector component.

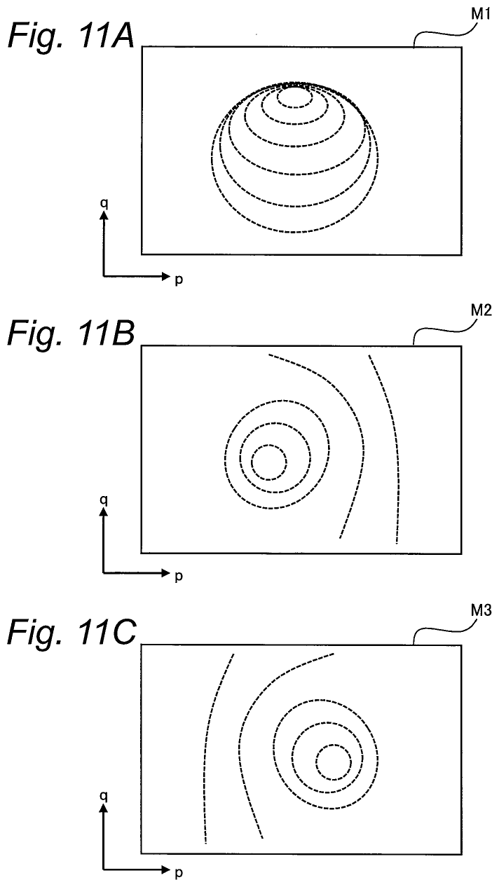

For example, the controller 310 in the present system 10, referring to the illuminance distribution data D1 to D3 of the respective illumination light sources 211 to 213 (S11), creates a reflectance map using two variables p and q in the normal direction N (S12). FIGS. 11A to 11C illustrate reflectance maps M1 to M3 corresponding to the respective illumination light sources 211 to 213.

FIG. 11A illustrates the reflectance map M1 corresponding to the illuminance distribution data D1 of FIG. 9A. FIG. 11B illustrates the reflectance map M2 corresponding to FIG. 9B, and FIG. 11C illustrates the reflectance map M3 corresponding to FIG. 9C. For example, the reflectance maps M1 to M3 indicate a distribution of a ratio at which reflected light of illumination light from a specific light source position is received on a pq plane, and include contour lines regarding brightness of the reflected light. The pq plane is defined by a coordinate system of the two variables p and q corresponding to various normal directions N by Gaussian mapping, for example.

Based on the illuminance distribution data D1 to D3 from the plurality of illumination light sources 211 to 213 and the corresponding reflectance maps M1 to M3, the controller 310 performs calculation processing to estimate the normal direction N (i.e., the inclination of the surface) and the reflection coefficient ρ of the surface position Pa of the subject 11, by using the photometric stereo method, for example (S13). The controller 310 calculates the following equations (1) to (3), assuming a Lambertian surface, for example.

I₁=L₁×ρ×\vec{S₁}·\vec{N}_{p, q} (1)

I₂=L₂×ρ×\vec{S₂}·\vec{N}_{p, q} (2)

I₃=L₃×ρ×\vec{S₃}·\vec{N}_{p, q} (3)

In the above equations (1) to (3), Ln represents the light intensity of the illumination light by the n-th illumination light sources 211 to 213 (n=1, 2, and 3). Sn indicates the light beam direction from the n-th illumination light sources 211 to 213 as a unit vector. In represents illuminance received as the illuminance distribution data D1 to D3 by the n-th illumination light source 211 to 213. In the above equations (1) to (3), “×” represents multiplication, and “·” represents an inner product between vectors. The above equations (1), (2), and (3) correspond to the reflectance maps M1, M2, and M3 of FIGS. 9A to 9C, respectively.

For example, as the above equations (1) to (3) have three variables to be estimated such as the two variables p and q in the normal direction N and the reflection coefficient ρ, the estimated value of each variable can be obtained based on the information of the light reception result by the first to third illumination light sources 211 to 213. For example, the controller 310 executes the calculation of the above equations (1) to (3) for each light receiving position pa in the light reception coordinates (x, y) (S13).

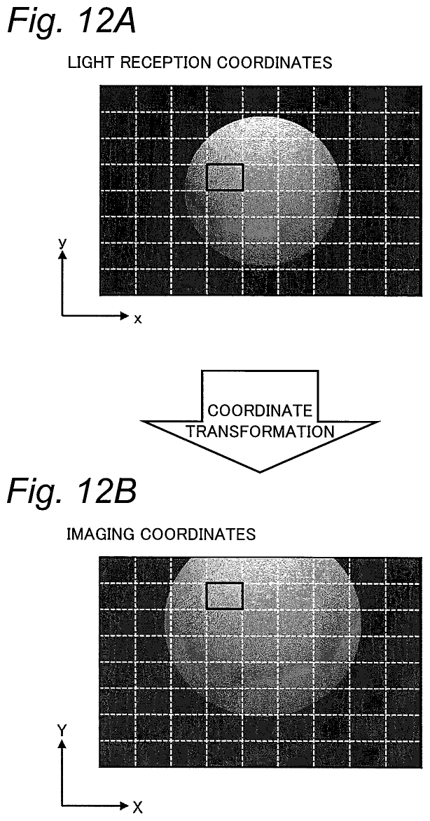

Next, the controller 310 converts the estimation information indicating the estimation result of the normal direction N and the reflection coefficient ρ of the subject 11 as described above from the light reception coordinates (x, y) to the imaging coordinates (X, Y) (S14). The imaging coordinates (X, Y) are a coordinate system indicating a position on the captured image indicated by the image data to be corrected, and shows a position on the imaging surface of the image sensor 115 of the digital camera 100. FIGS. 12A and 12B illustrate the light reception coordinates (x, y) and the imaging coordinates (X, Y) before and after conversion in step S14, respectively.

For example, the coordinate transformation in step S14 is calculated by triangulation according to the positional relation between the digital camera 100 and the illumination device 200 at the image-shooting site 15 in the present system 10. In this processing, the subject distance may be a focal length in imaging by the digital camera 100 or light reception by the illumination device 200. For example, the controller 310 acquires various information for coordinate transformation in the present system 10 in advance in steps S1, S2, and the like of FIG. 7, and executes the processing of step S14.

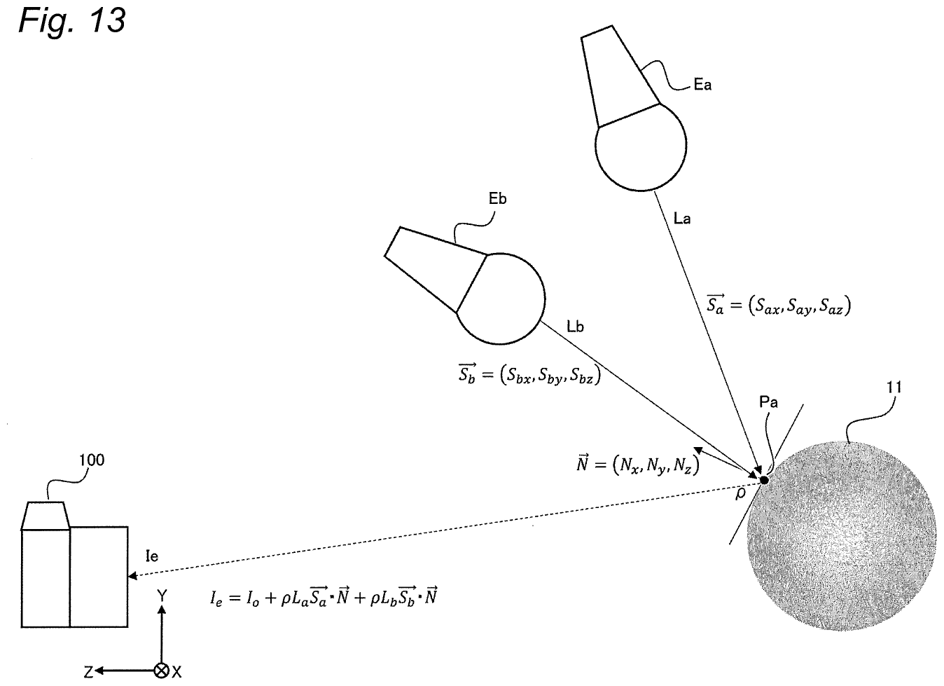

The controller 310 calculates the illumination effect according to the setting information of the virtual illumination acquired in step S3 of FIG. 7, based on the estimation information of the subject 11 converted into the imaging coordinates (X, Y) as described above, to generate the retouched image (S15). The processing of step S15 will be described with reference to FIG. 13.

FIG. 13 illustrates the virtual illumination equipment Ea and Eb set by a user operation on the illumination editing screen of FIG. 6 in a three-dimensional coordinate system (X, Y, Z) corresponding to imaging coordinates (X, Y) of the digital camera 100. The controller 310 specifies light emission intensities La and Lb and light beam directions Sa and Sb of the virtual illumination equipment Ea and Eb, based on the setting information of the virtual illumination acquired from the user operation in step S3 of FIG. 7, for example. For example, when receiving a user operation of arranging the virtual illumination equipment Ea and Eb on the virtual illumination setting region R1 (FIG. 6), the controller 310 performs coordinate transformation similar to step S14.

Based on the various parameters La, Lb, Sa, and Sb of the virtual illumination equipment Ea and Eb and the normal direction N and the reflection coefficient ρ of the estimation result of the subject 11, the controller 310 calculates the illumination effect of the virtual illumination as in the following equation (10), for example (S15).

Iₑ=Iₒ+ρLₐ\vec{Sₐ}·\vec{N}+ρL_{b}\vec{S_{b}}·\vec{N} (10)

In the above equation (10), Io represents the brightness of the original image before correction, and Ie represents the brightness of the retouched image, each constituting a (monochromatic) pixel value, for example. For example, the controller 310 performs the calculation of the above equation (10) for each pixel position in the imaging coordinates (X, Y). As a result, the controller 310 performs correction to add the illumination effect of the virtual illumination to the original image and generates a retouched image (S15).

By generating the retouched image as described above (S15), the controller 310 ends the image processing of virtual illumination (S4). Thereafter, the controller 310 displays the generated retouched image in the retouched image region R3 (FIG. 6) of the illumination editing screen and proceeds to step S5 in FIG. 7, for example.

According to the image processing of virtual illumination (S4) described above, the normal direction N and the reflection coefficient ρ of the subject 11 at the image-shooting site 15 are estimated from the illuminance distribution data D1 to D3 obtained by using the plurality of illumination light sources 211 to 213 in the illumination device 200 at the image-shooting site 15 (S13). Accordingly, the illumination effect of the virtual illumination desired by the user can be accurately calculated (S15).

In step S13 described above, the calculation equations (1) to (3) for estimating the photometric stereo method have been exemplified. In the present system 10, the estimation calculation in step S13 is not particularly limited to the above equations (1) to (3), and various changes can be made. For example, the number of illumination light sources 21 may be increased to 4 or more, and simultaneous calculation equations may be increased.

In addition, although the assumption of the Lambertian surface is used in the above equations (1) to (3), various calculation equations not particularly limited to this assumption may be applied, or an AI technology such as a machine learning model may be applied. The controller 310 can calculate the illumination effect of the virtual illumination according to various estimation methods by applying calculation similar to the estimation calculation of step S13 to step S15.

In step S14 described above, an example has been described in which triangulation is used for coordinate transformation between the light reception coordinates (x, y) of the illumination device 200 and the imaging coordinates (X, Y) of the digital camera 100. The processing of step S14 is not particularly limited to the above, and for example, distance measurement may be performed by DFD (Depth From Defocus) or the like in the digital camera 100. Furthermore, a distance measuring sensor such as a time of flight (TOF) sensor may be used in the present system 10. Furthermore, various image recognition methods for estimating the positional relation between the images corresponding to the illuminance distribution data D1 to D3 of the illumination device 200 and the captured image of the digital camera 100 may be used, for example. Step S14 may be realized by using various AI technologies such as a machine learning model of image recognition.

In steps S13 to S14 described above, the controller 310 may manage the estimation information of the subject 11 as model data indicating the three-dimensional shape. For example, the reflection coefficient ρ may be managed in association with each unit in the model data together with the normal direction N.

The processing of steps S11 to S14 described above may not be performed every time in the repetition cycle of steps S3 to S5 of FIG. 7. For example, the results of the first steps S11 to S14 may be used for subsequent processing, and the processing may be appropriately omitted.

### 3. Summary

As described above, in the present embodiment, the video editing PC 300, which is an example of the image processing apparatus, includes the communication interface 350 as an example of first and second input interfaces, the user interface 330, and the controller 310. The communication interface 350 as the first input interface acquires image data (i.e., first image data) indicating an original image in which the subject 11 is imaged by the digital camera 100 in a shooting environment such as the image-shooting site 15 (S1). The communication interface 350 as the second input interface acquires the illuminance distribution data D1 to D3 as an example of illuminance distribution information indicating a distribution based on the illumination light radiated onto the subject 11 from the illumination device 200 at the image-shooting site 15 (S2). The user interface 330 receives a user operation for setting virtual illumination (S3). The controller 310, referring to the illuminance distribution information, retouches the first image data so as to apply an illumination effect corresponding to the virtual illumination set by the user operation to the original image, to generate image data (i.e., a second image data) indicating an image of a correction result (S4).

According to the above image processing apparatus, by using the illuminance distribution data D1 to D3 of the image-shooting site 15 obtained by the illumination device 200, it is possible to facilitate to realize the illumination effect according to the intention of the user in the image shot with the digital camera 100.

In the present embodiment, the illumination device 200 emits illumination light respectively from a plurality of light source positions different from each other by the plurality of illumination light sources 211 to 213. The illuminance distribution data D1 to D3 include a plurality of illuminance distributions each obtained by receiving reflected light of each illumination light from the plurality of light source positions. The controller 310 applies the illumination effect of the virtual illumination to the original image, based on the difference between the plurality of illuminance distributions in the illuminance distribution data D1 to D3 (S11 to S15). Accordingly, the illumination effect according to the difference in illuminance distribution of the subject 11 obtained at the image-shooting site 15 can be applied to the original image, and thus the illumination effect according to the intention of the user can be obtained with high accuracy.

In the present embodiment, the illumination device 200 includes the light receiver 220 having the light receiving surface that receives reflected light of each illumination light radiated from the plurality of light source positions. The illuminance distribution data D1 to D3 indicate, as the plurality of illuminance distributions, results of the light receiver 220 receiving the reflected light of each illumination light from the plurality of light source positions on the light receiving surface. Consequently, the illuminance distribution data D1 to D3 in which illumination beams from the different light source positions are received at the common light receiving position pa are obtained, and analysis such as the photometric stereo method can be easily realized.

In the present embodiment, the controller 310 calculates the normal direction N and the reflection coefficient ρ indicating the reflectance in the subject 11, based on the difference between the plurality of illuminance distributions in the illuminance distribution data D1 to D3 (S13), and applies the illumination effect of the virtual illumination to the original image based on the calculation result of the normal direction N and the reflection coefficient ρ in the subject 11 (S15). Accordingly, it is possible to easily obtain a natural illumination effect suitable for the actual subject 11 based on the illuminance distribution data D1 to D3 of the image-shooting site 15.

In the present embodiment, the video editing PC 300 further includes the display 340 that displays environment information indicating the image-shooting site 15. The user interface 330 receives a user operation of setting a virtual illumination arrangement in the image-shooting site 15 in the environment image G1 as an example of the environment information displayed on the display 340 (see FIG. 6). Accordingly, the user can easily designate desired virtual illumination at the image-shooting site 15.

In the present embodiment, the environment image G1 indicates the image-shooting site 15 in a wider range than the original image. Accordingly, the user can designate to arrange the virtual illumination equipment Ea and Eb and the like outside the field angle range of the original image, and a desired illumination effect can be easily obtained. Such an environment image G1 can be generated from the illuminance distribution data D1 to D3 by the illumination device 200, for example. Note that such environment information may not be image information, and may be information obtained by appropriately modeling the image-shooting site 15, for example.

In the present embodiment, the imaging system 10 includes the digital camera 100 that captures an image of the subject 11 to generate the first image data, and an image processing apparatus such as the video editing PC 300. The image processing apparatus generates the second image data by retouching the first image data to apply an illumination effect to the original image indicated by the first image data generated by the digital camera 100. With such an imaging system 10, it is possible to easily realize the illumination effect according to the intention of the user in the shot image.

In the present embodiment, the illumination device 200 is a device that irradiates the image-shooting site 15 of the subject 11 with illumination light, to generate the illuminance distribution data D1 to D3 for image processing to retouch the shot original image. The illumination device 200 includes the light emitter 210 that individually emits the illumination light from the plurality of light source positions different from each other, and the light receiver 220 that receives the reflected light of each illumination light irradiated from the plurality of light source positions and generates the illuminance distribution data D1 to D3 including the distribution of the illumination light irradiated to the subject 11. According to the illumination device 200, it is possible to easily realize the illumination effect according to the intention of the user in the image shot at the image-shooting site 15.

### Second Embodiment

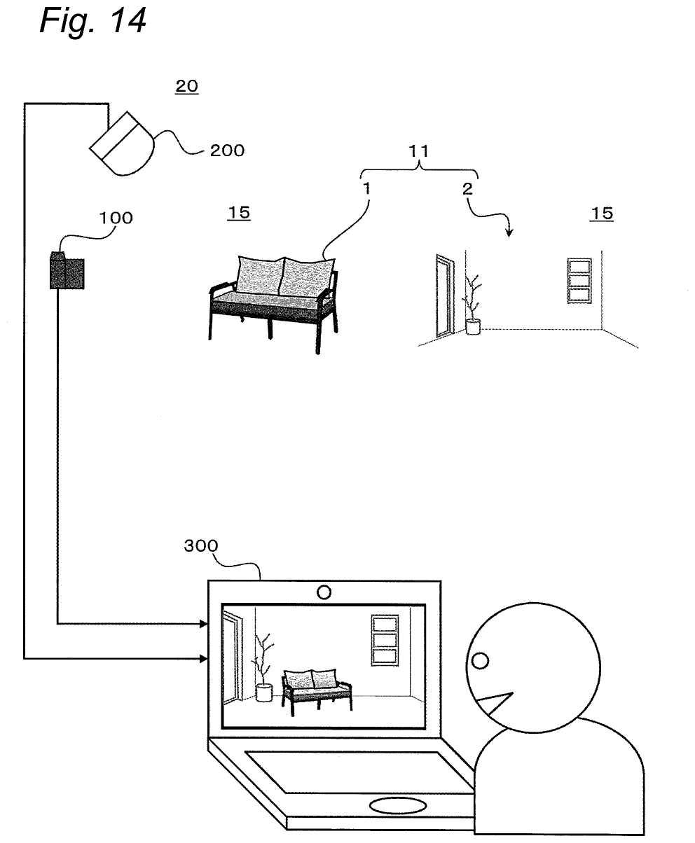

A virtual illumination system according to a second embodiment of the present disclosure will be described with reference to FIGS. 14 to 21. Hereinafter, description of configurations and operations similar to those of the imaging system 10 according to the first embodiment will be omitted as appropriate, and a virtual illumination system 20 according to the present embodiment will be described.

### 1. Configuration

As illustrated in FIG. 14, the virtual illumination system 20 according to the present embodiment includes the digital camera 100, the illumination device 200, and the information terminal 300, for example. For example, the present system 20 is applicable to an arrangement simulation that is an image synthesis simulation for visualizing a state in which an article 1 such as furniture desired by a customer is virtually arranged on a background 2 of a separately desired room or the like in an interior shop, a real estate company, or the like. The article 1 and the background 2 are examples of subjects respectively imaged at different image-shooting sites 15, for example.

In such an arrangement simulation, even if the captured image of the article 1 and the captured image of the background 2 are combined, there may be a problem that the combined image becomes unnatural due to inconsistency in illuminance or the like of the image-shooting sites 15 different between the images. Therefore, in the present system 20, the illumination device 200 for performing image processing of the illumination effect afterwards is used together at the time of imaging the article 1 or the like by the digital camera 100. Then, the present system 20 realizes a natural illumination effect that resolves the inconsistency in the composite image at the time of arrangement simulation.

The configuration of each of the devices 100, 200, and 300 in the present system 20 is similar to the configuration in the first embodiment, for example.

The illumination device 200 of the present system 20 includes various types such as a ceiling installation type or a stand type. The illumination device 200 may be a clip-on type mounted on the digital camera 100, or may be configured integrally with a photographing box that houses a subject.

The information terminal 300 is an example of an image processing apparatus including a personal computer, a smartphone, a tablet terminal, or the like, for example. Furthermore, various display devices such as a projector and a head mounted display may be used for the display 340 of the information terminal 300. Furthermore, in an exemplary case where an external display device is used, the display 340 of the information terminal 300 may be an output interface circuit of a video signal or the like conforming to the HDMI standard or the like, for example.

### 2. Operation

The operation of the virtual illumination system 20 configured as described above will be described below.

In the present system 20, the digital camera 100 images the article 1 to be subjected to the arrangement simulation in advance, for example. In such an article imaging operation, the present system 20 acquires specific information by using the illumination device 200. Furthermore, in the present embodiment, the imaging operation using the digital camera 100 and the illumination device 200 is performed also for the background 2 of the arrangement simulation. The present system 20 reproduces a state in which the article 1 is arranged on the background 2 according to the operation of the user in the arrangement simulation, based on the imaging result as described above, to provide the illumination effect of the virtual illumination.

Hereinafter, details of the operation of the present system 20 will be described. Hereinafter, an operation example using the information terminal 300 will be described as an example of the operation of the present system 20, but the imaging operations and arrangement simulation processing may be performed without particularly using the same terminal.

### 2-1. Article Imaging Operation

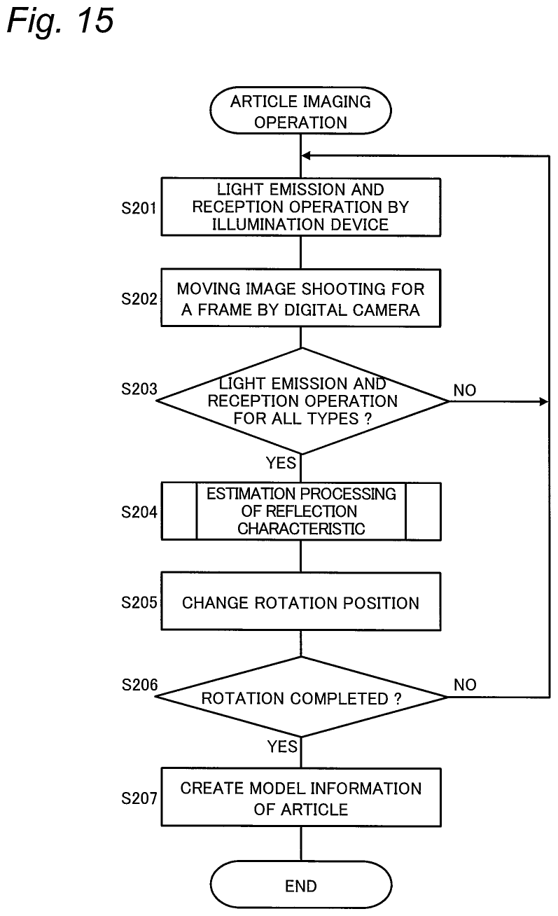

An example of the article imaging operation in the present system 20 will be described with reference to FIGS. 15 to 17. In the present operation example, a moving image or the like is captured by the digital camera 100 over the entire circumference of the article 1 as an example of a subject, during the information acquisition by the illumination device 200. Accordingly, the orientation of the article 1 can be variable over the entire circumference in the subsequent arrangement simulation.

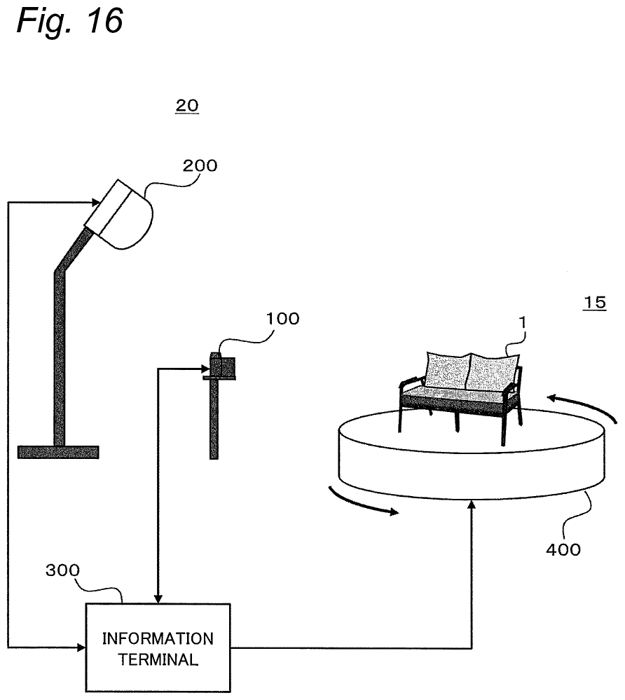

FIG. 15 is a flowchart illustrating an article imaging operation in the present system 20. FIG. 16 illustrates an environment of the article imaging operation of FIG. 15. Each processing of the flowchart illustrated in FIG. 15 is executed by the controller 310 of the information terminal 300, for example.

In the present operation example, as illustrated in FIG. 16, a rotation table 400 that rotates the article 1 to be imaged is used, for example. For example, the rotation table 400 is, including a stage on which the article 1 is placed, a motor and the like, configured to be rotationally driven to various angular positions in one cycle from 0 degrees to 360 degrees corresponding to the entire circumference of the article 1. In the present operation example, the information terminal 300 is connected to each of the devices 100, 200, and 400 so as to communicate data with each other, and controls the operation of each of the devices 100, 200, and 400. Further, in FIG. 16, the stand type illumination device 200 is illustrated, but the present disclosure is not particularly limited thereto.

For example, as illustrated in FIG. 15, the controller 310 of the information terminal 300 transmits a control signal to cause the illumination device 200 to execute operations of emitting and receiving illumination light (S201). The controller 310 acquires illuminance distribution data (see FIGS. 9A to 9C) regarding the illumination light radiated onto the article 1 from the illumination device 200 via the communication interface 350, for example.

For example, in the illumination device 200, the controller 230 causes the first to third illumination light sources 211 to 213 to sequentially emit light in the light emitter 210 according to the control signal from the information terminal 300, and receives the reflected light of each of the illumination light sources 211 to 213 in time division in the light receiver 220. The controller 230 of the illumination device 200 generates illuminance distribution data indicating the light reception result for each illumination light source 21, and transmits the illuminance distribution data to the information terminal 300 via the communication interface 250. The illuminance distribution data is generated for each color such as RGB. For example, the illumination device 200 sequentially emits one type of illumination light of the illumination light for each color in each illumination light source 21 at every step S201.

Furthermore, the controller 310 transmits control signal to the digital camera 100 so that the digital camera 100 executes a shooting operation for each frame of a moving image, for example (S202). The information terminal 300 acquires the moving image data output from the digital camera 100 via the communication interface 350, for example. In the present embodiment, the imaging operation of the digital camera 100 may be performed during light emission of the illumination device 200, or may be performed during stop of the light emission. For example, among all of the captured images, an image captured during stop of the light emission is used as the image showing the appearance of the article 1 in the model information. The model information of the article 1 may be generated using a captured image in a state where the article 1 is illuminated with various illumination beams.

For example, in the digital camera 100, the controller 135 controls the exposure timing of the image sensor 115 according to a control signal from the information terminal 300, and causes the digital camera 100 to sequentially capture a frame image at every step S202. For example, the frame image captured in one step S202 indicates the appearance of the article 1 viewed from the digital camera 100 in an orientation corresponding to the angular position of the rotation table 400. For example, the digital camera 100 outputs moving image data as an example of image data of such an image shooting result from the communication module 155. Note that the digital camera 100 may perform continuous shooting of still images instead of the moving image shooting, or may repeat single image shooting.

For example, the controller 310 determines whether or not the illumination device 200 has performed the light emission and reception operation for all types of illumination light in a state where the rotation table 400 is at a specific angular position (S203). All types of illumination light include illumination light of each color in each of the first to third illumination light sources 211 to 213. When the illumination device 200 does not perform all types of light emission and reception operations (NO in S203), the controller 310 changes the type of illumination light and repeats the processing of steps 5201 to 5203.

For example, when the illumination device 200 performs all types of light emission and reception operations (YES in S203), the controller 310 performs calculation processing to estimate characteristics of the article 1 reflecting various types of illumination light, based on illuminance distribution data acquired from the illumination device 200 (S204). In the estimation processing of a reflection characteristic (S204), estimation information indicating the estimation result of the reflection characteristic such as the normal direction of various positions on the surface of the article 1 and the reflectance of each color light is generated for each of various angular positions at which the article 1 is imaged, for example. Details of the processing of step S204 will be described later.

Furthermore, the controller 310 controls the rotation table 400 to change the angular position by a predetermined rotation angle, for example (S205). The rotation angle in step S205 is appropriately set (e.g., 15 degrees) from the viewpoint of updating the portion imaged by the digital camera 100 in the appearance viewed from the periphery of the article 1 on the rotation table 400 for each frame. For example, the rotation of the rotation table 400 is intermittently performed every step S203.

For example, the controller 310 determines whether or not the circling of the article 1 for the entire circumference (e.g., rotation by 360 degrees) by the rotation table 400 is completed, based on the changed angular position (S206). When the circling by the rotation table 400 is not completed (NO in S206), the controller 310 performs the processing of step S202 and subsequent steps again for the new angular position. By repeating steps S201 to S206, moving image data and illuminance distribution data of an imaging result over the entire circumference of the article 1 are acquired.

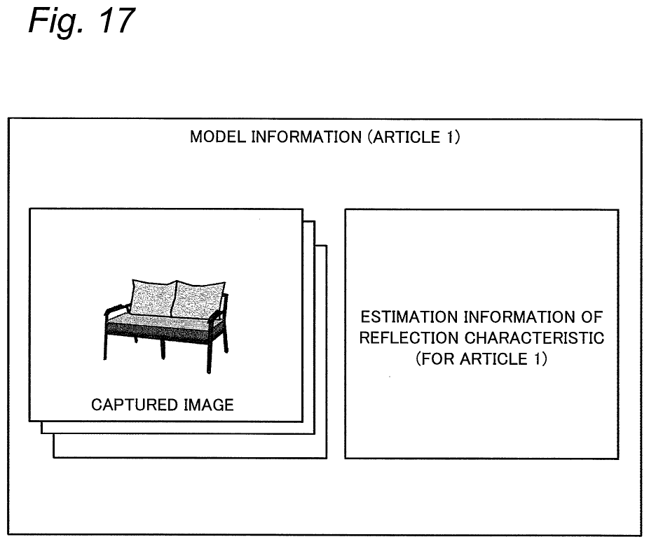

For example, when the circling by the rotation table 400 is completed (YES in S206), the controller 310 creates the model information of the article 1, based on the moving image data acquired from the digital camera 100 and the estimation information of the reflection characteristic generated every step S204 (S207). The model information of the article 1 is an example of first model information indicating a model of the article 1 (object) used for arrangement simulation in a three-dimensional shape, for example. A data structure of the model information in the present system 20 is illustrated in FIG. 17.

For example, as illustrated in FIG. 17, the model information of the article 1 in the present example includes a captured image showing the appearance of the article 1 over the entire circumference of the article 1 and reflection characteristic of the article 1 on the captured image. The reflection characteristic includes a characteristic that light is reflected at different positions on the captured image. For example, the controller 310 associates the normal direction and the reflectance estimated at various positions in each frame image corresponding to different angular positions in the moving image data. The controller 310 may clop a region where the article 1 appears from each frame image and process the region. Such model information may be managed in various data structures, and may be managed as meta information of moving image data and each frame thereof, for example. Furthermore, a three-dimensional image obtained by combining a plurality of captured images and a reflectance model in which a reflection characteristic is associated with each position in the three-dimensional shape of the article 1 may be managed.

For example, the controller 310 stores the generated model information (S207) of the article 1 in the memory 320, and ends the processing of this flow.

According to the article imaging operation described above, illuminance distribution data is acquired by the illumination device 200 simultaneously with imaging of the entire circumference of the article 1 by the digital camera 100 (S201 to S206). Then, the model information for realizing virtual illumination for the entire circumference of the article 1 can be obtained (S207).

In steps S201 and S202 described above, an example has been described in which the operation timing of capturing a moving image or the like is controlled by the information terminal 300, but the operation timing may not be particularly controlled by the information terminal 300. For example, one of the digital camera 100 and the illumination device 200 may control the operation timing of the other, and the devices 100 and 200 may be connected to communicate with each other to transmit and receive a control signal.

In step S205 described above, an example has been described in which the information terminal 300 controls the rotation of the rotation table 400, but the information terminal 300 may not perform the rotation control. For example, the rotation table 400 may execute rotation by an instruction from the digital camera 100 or the illumination device 200, a user operation, or the like. Alternatively, the rotation table 400 that is manually rotated by the user may be used. The information terminal 300 may acquire information indicating the angular position from the rotation table 400, or may estimate the angular position from the captured image of the digital camera 100. The rotation of the rotation table 400 is not limited to be intermittent, and may be continuous.

The plurality of frame images captured during the repetition of steps S201 to S203 may be used for generating a composite image as an imaging result of the digital camera 100. For example, the digital camera 100 may perform various image syntheses such as depth synthesis, high dynamic range (HDR) synthesis, and super-resolution synthesis, based on a plurality of frame images from such specific angular positions, to generate a synthesized image. Such a composite image may be used as the model information in step S207.

Furthermore, in the above description, an example has been described in which the digital camera 100 and the illumination device 200 are operated simultaneously in the article imaging operation (FIG. 15), but the article imaging operation may not be particularly performed simultaneously. For example, the entire circumference of the article 1 may be imaged by the digital camera 100. The light emission and reception operation by the illumination device 200 may be separately performed for the entire circumference of the article 1. The information terminal 300 appropriately inputs the information acquired by each of the devices 100 and 200 in this way, and can perform the processing of step S204 and subsequent steps in FIG. 15.

### 2-1-1. Estimation Processing of Reflection Characteristic

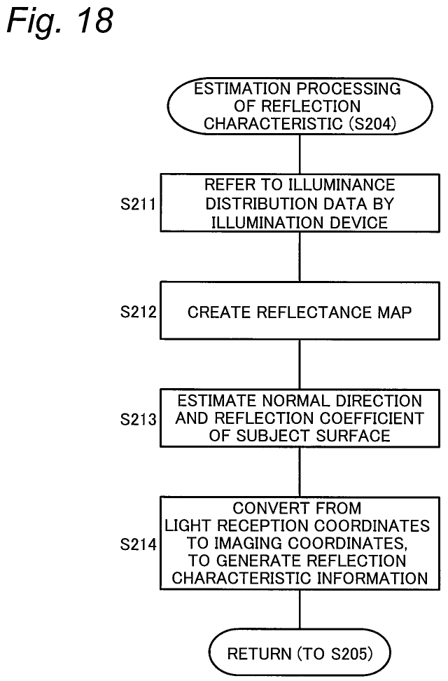

The estimation processing of a reflection characteristic of step S204 in FIG. 15 will be described with reference to FIG. 18. FIG. 18 is a flowchart for explaining the estimation processing of a reflection characteristic (S204) in the present system 20. In the estimation processing of a reflection characteristic (S204) in the present embodiment, the controller 310 executes processing similar to steps S11 to S14 in the image processing of the virtual processing (S4) in the first embodiment, for example (S211 to S214).

At first, the controller 310 of the present system 20 refers to the illuminance distribution data acquired in step S201 repeated in steps S201 to S203 of FIG. 15, for example (S211). For example, such illuminance distribution data includes illuminance distribution data of each light reception result according to the emission of the illumination light of each color in each of the first to third illumination light sources 211 to 213 in a state where the position of the subject such as the article 1 is the same.

For example, similarly to steps S11 and S12 of the first embodiment, the controller 310 in the present system 20, referring to the illuminance distribution data D1 to D3 (FIGS. 9A to 9C) of the respective illumination light sources 211 to 213 (S211), creates the reflectance maps M1 to M3 (FIGS. 11A to 11C) (S212).

The controller 310 performs calculation processing of estimating the normal direction N and the reflection coefficient ρ of the surface position Pa of the subject 11 from the illuminance distribution data D1 to D3 by the plurality of illumination light sources 211 to 213 and the corresponding reflectance maps M1 to M3 by the photometric stereo method (S213). The calculation processing of step S213 is performed similarly to step S13 of the first embodiment, for example.

Next, similarly to step S14 of the first embodiment, the controller 310 converts the estimation information indicating the estimation result of the normal direction N and the reflection coefficient ρ of the subject 11 from the light reception coordinates (x, y) to the imaging coordinates (X, Y), and generates the estimation information of the reflection characteristic (S214).

For example, after generating the estimation information of the reflection characteristic for the corresponding frame image in the moving image data (S214), the controller 310 ends the estimation processing of a reflection characteristic (S204 in FIG. 15), and proceeds to step S207.

According to the estimation processing of a reflection characteristic (S204), the normal direction N and the reflection coefficient ρ of the subject 11 can be estimated from the illuminance distribution data D1 to D3 obtained by using the plurality of illumination light sources 211 to 213 in the illumination device 200 in the shooting environment of the subject such as the article 1 (S213).

For example, by step S204 repeated in steps S201 to S206 in FIG. 15, the controller 310 generates estimation information of the reflection characteristics for the corresponding angular positions. For example, the controller 310 performs processing similar to steps S211 to S214, based on all types of illuminance distribution data for each angular position, thereby generating illuminance distribution data for the angular position. Alternatively, the controller 310 may sequentially generate the estimation information for the corresponding frame image by correcting the estimation information of the initial reflection characteristic using the estimation information of the reflection characteristic generated in the initial stage and the illuminance distribution data of each time of step S201 after the initial stage.

Furthermore, in the above description, an example has been described in which the estimation processing of the reflection characteristic (S204 in FIG. 15) is performed by the information terminal 300 during the repetition of steps S201 to S206. The processing of step S204 is not particularly limited thereto, and may be performed after the repetition of steps S201 to S206, for example.

Furthermore, the estimation processing of the reflection characteristic (S204) may be performed in the illumination device 200. The illumination device 200 may transmit the estimation information of the reflection characteristic instead of the illuminance distribution data to the information terminal 300 as an example of the illuminance distribution information.

### 2-2. Background Imaging Operation

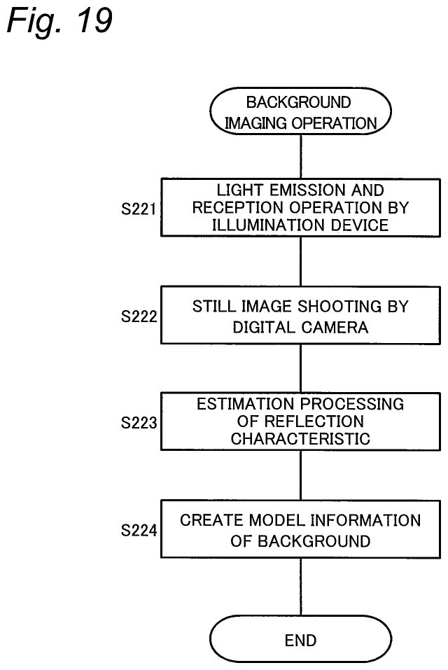

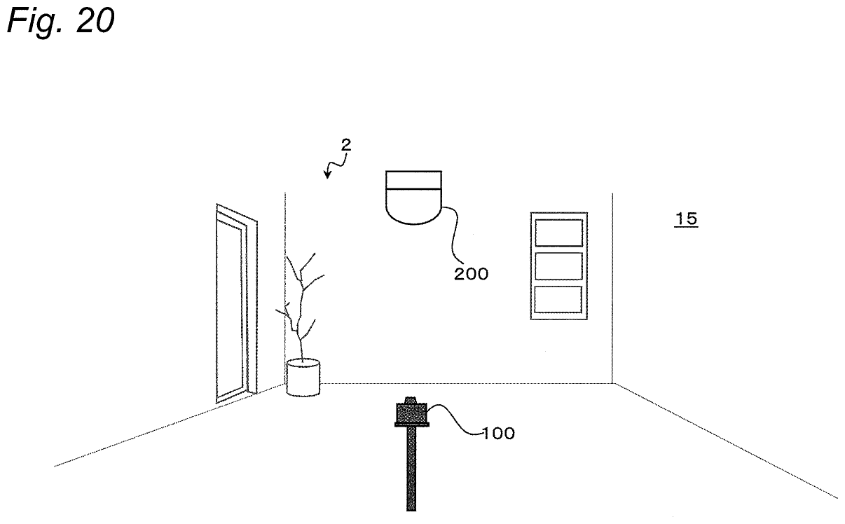

An example of an operation of acquiring information by the illumination device 200 and capturing an image by the digital camera 100 for the background 2 in the present system 20 will be described with reference to FIG. 19 to 20. Hereinafter, an operation example of the present system 20 by still image capturing will be described.

FIG. 19 is a flowchart illustrating a background imaging operation in the present system 20. FIG. 20 illustrates an environment of the background imaging operation of FIG. 19. Each processing of the flowchart illustrated in FIG. 19 is executed by the controller 310 of the information terminal 300, for example.

In the present operation example, as illustrated in FIG. 20, the digital camera 100 is fixedly arranged by a tripod or the like, for example. In addition, the illumination device 200 is exemplified by a ceiling installation type as an example. Each of the devices 100 and 200 may not be the same device as the devices 100 and 200 used in the article imaging operation (FIG. 16). Also in this operation example, it is assumed that the information terminal 300 is connected to each of the devices 100 and 200 so as to be able to perform data communication.

For example, the controller 310 of the information terminal 300 causes the illumination device 200 to execute the light emission and reception operation similarly to step S201 of FIG. 15 (S221). In step S221, the controller 310 acquires all types of illuminance distribution data for the illumination beams of the respective colors in the first to third illumination light sources 211 to 213 from the illumination device 200, for example.

Furthermore, the controller 310 causes the digital camera 100 to execute a still-image shooting operation, for example (S222). The controller 310 acquires image data of an imaging result from the digital camera 100. The processing order of steps S221 and S222 is not particularly limited. Furthermore, in steps S221 and S222, the controller 310 may not particularly control the operation timing of each of the devices 100 and 200, and may appropriately acquire each data of the operation result of each of the devices 100 and 200.

Furthermore, the controller 310 performs estimation processing of a reflection characteristic for the background 2, based on the illuminance distribution data by the illumination device 200, for example (S223). In step S23, the controller 310 performs processing similar to steps S211 to S214 in FIG. 18, to generate the estimation information of the reflection characteristic for the background 2, for example.

Next, the controller 310 creates the model information of the background 2, based on the image data by the digital camera 100 and the estimation information of the reflection characteristic for the background 2, similarly to step S207 in FIG. 15, for example (S224). The model information of the background 2 is an example of second model information indicating the model of the background 2 in the arrangement simulation similarly to the model information of the article 1. The model information of the background 2 indicates the normal direction and the reflectance estimated for each position in the captured image of the background 2 in association with each other, with two dimensions based on the imaging coordinates of the digital camera 100, for example. For example, the model information of the background 2 may be managed as still image data and its meta information.

For example, the controller 310 stores the generated model information (S224) of the background 2 in the memory 320, to end the processing of this flow.

According to the background imaging operation described above, for the room or the like used as the background 2 of the arrangement simulation, the model information, in which the captured image and the estimation information of the reflection characteristic are associated with each other, can be obtained using the digital camera 100 and the illumination device 200 (S221 to S224).

In the above description, an operation example in which one time of the still image shooting (S222) is performed in the background imaging operation has been described. However, still image shooting may be performed a plurality of times, or capturing of a moving image may be performed. For example, in the example of FIG. 20, a plurality of captured images corresponding to different orientations may be acquired while the digital camera 100 is axially rotated at a fixed position. In this case, also for the model information of the background 2, a plurality of captured images and respective reflection characteristics may be managed in a three-dimensional shape.

In the above description, the background imaging operation using the illumination device 200 has been described. In the present system 20, the illumination device 200 may not be particularly used for the background 2, and only image capturing by the digital camera 100 may be performed. For example, the controller 310 may estimate the reflection characteristic regarding the ambient light of the background 2 by an image estimation method, based on the captured image of the background 2.

In the above description, an example has been described in which the imaging result by the digital camera 100 is used as the model information of the background 2, but the present disclosure is not particularly limited thereto. For example, the model information of the background 2 may include a two-dimensional or three-dimensional image generated by computer graphics (CG) or the like and information of reflection characteristics. The following arrangement simulation processing can be performed using such model information of the background 2. As to the model information of the article 1, an image of CG may be used instead of the imaging result of the article 1. Meanwhile, by using the imaging result of the article 1 or the background 2, the reality such as the texture of a corresponding subject in the simulated image can be improved.

### 2-3. Arrangement Simulation Processing

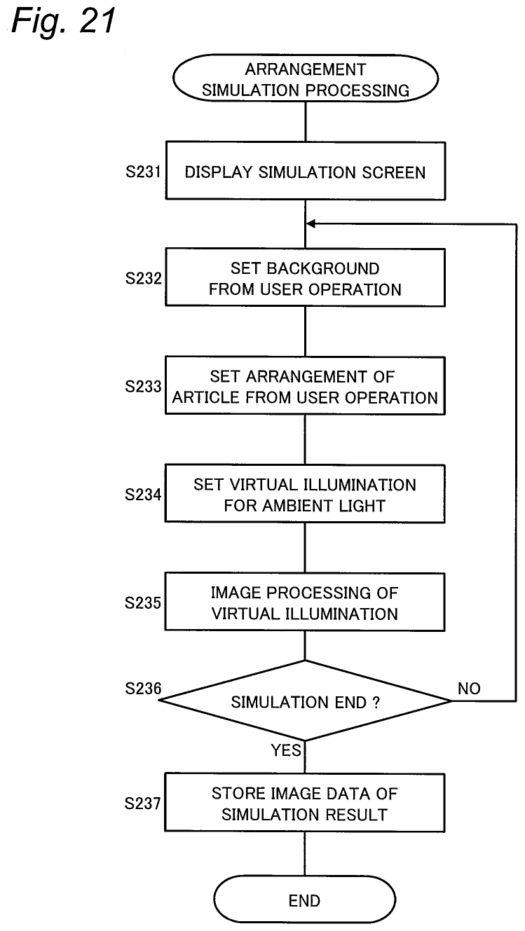

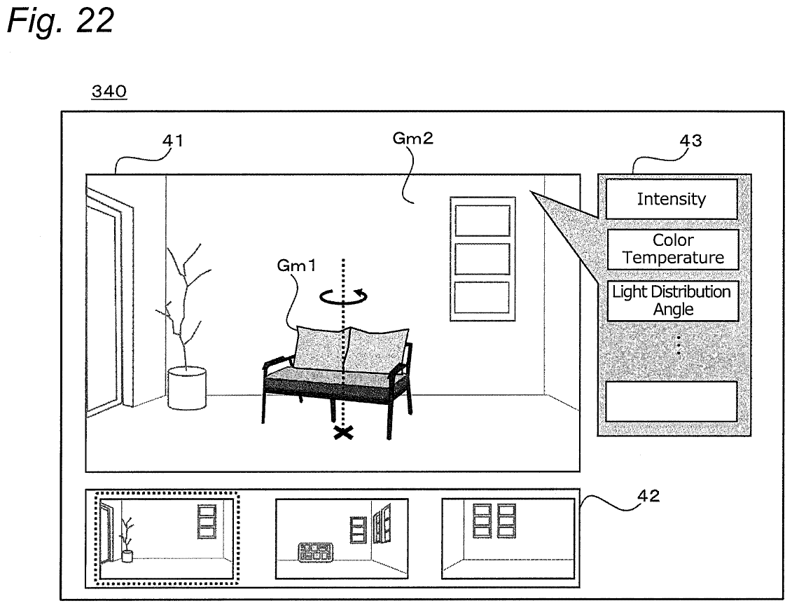

An operation of performing the arrangement simulation using each model information of the article 1 and the background 2 obtained as described above in the virtual illumination system 20 of the present embodiment will be described with reference to FIGS. 21 to 22.

FIG. 21 is a flowchart illustrating arrangement simulation processing in the present system 20. FIG. 22 illustrates a display example of the arrangement simulation processing of FIG. 21.

Each processing illustrated in the flowchart of FIG. 21 is started with the various model information being stored in the memory 320 of the information terminal 300, and is executed by the controller 310, for example.

At first, the controller 310 causes the display 340 to display a screen for performing an arrangement simulation for the article 1 selected in advance (S231). A display example of step S231 is illustrated in FIG. 22.

FIG. 22 illustrates a display example of a simulation screen in the present system 20. For example, the simulation screen displayed on the display 340 of the information terminal 300 includes a simulation image field 41, a background selection field 42, and an illumination setting field 43. The simulation image field 41 is a field for visualizing the arrangement simulation of the article 1, by displaying various images including an article image Gm1 generated by the model information of the article 1 and a background image Gm2 generated by the model information of the background 2, for example.

For example, the controller 310 is operable to receive various user operations via the user interface 330 with a simulation screen as exemplified in FIG. 22 being displayed on the display 340 (S232 to S234). At step S231, the simulation image field 41 may display the article image Gm1 without displaying the background image Gm2.

The controller 310 sets the background in the arrangement simulation according to the user operation in the background selection field 42, for example (S232). For example, the background selection field 42 includes a thumbnail image for enabling an input of a user operation for selecting a desired background from a plurality of preset background candidates. For example, the controller 310 reads the model information of the background 2 selected by the user operation from the memory 320, and displays the captured image in the read model information of the background 2 as the background image Gm2 for the article image Gm1 superposed thereon in the simulation image field 41.

Furthermore, the controller 310 sets the arrangement of the article 1, according to the user operation in the simulation image field 41, for example (S233). In step S233, a user operation to shift the position of the article image Gm1 with respect to the background image Gm2 of the simulation image field 41 or to rotate the orientation of the article image Gm1 can be input, for example. For example, the controller 310 extracts a frame image corresponding to an orientation desired by the user from frame images of the entire circumference in the model information of the article 1 according to a user operation of rotation, and displays the frame image in the simulation image field 41 as the article image Gm1.

Furthermore, the controller 310 sets virtual illumination indicating the ambient light in the arrangement simulation, according to the user operation in the illumination setting field 43, for example (S234). For example, the illumination setting field 43 inputs a user operation of setting illumination parameters such as the intensity, color temperature, and light distribution angle of the virtual ambient light. The controller 310 calculates an estimation value of the illumination parameter and the light source position for the ambient light at the time of imaging the background image Gm2, based on the model information of the background 2, for example. The estimated value of the illumination parameter is used as an initial value in the illumination setting field 43, for example.

Next, based on the background 2, the arrangement of the article 1, and the setting of the virtual illumination (S232 to S234) as described above, the controller 310 performs image processing of virtual illumination so as to apply a natural illumination effect to the article 1 arranged on the background 2 in the simulation image field 41 (S235).

In step S235, the controller 310 estimates the light source position of the virtual illumination Ea (see FIG. 13) from the background 2 by setting in steps S232 and S233 in FIG. 21, and specifies the light intensity La and the light beam direction Sa of the virtual illumination Ea from the illumination parameter set by the user operation or the like, for example. The controller 310 calculates the illumination effect of the virtual illumination, based on the various parameters La and Sa of the virtual illumination Ea and the normal direction N and the reflection coefficient ρ of the estimation result of the subject 11, similarly to step S15 of the first embodiment, for example (S235).

For example, in step S235, the controller 310 applies the illumination effect according to calculation similar to the above equation (10) using the article image Gm1 of the rotated frame by the user operation in the model information of the article 1 as the original image. In step S223, a calculation equation similar to the above equation (10) includes a term corresponding to a ray effect in the background image Gm2, for example. Furthermore, in a case where the illumination parameter of the virtual illumination Ea is changed from the estimation value (initial value) of the ambient light in the model information of the background 2 by the user operation, the controller 310 applies the illumination effect to the background image Gm2 by the change by the user operation in the same manner as described above, for example. According to the set arrangement of the article 1, the controller 310 generates a retouched image by image composition for superimposing the article image Gm1, to which the illumination effect is applied, on the background image Gm2, and displays the retouched image in the simulation image field 41.

For example, the controller 310, responding to various user operations with the retouched image as a result of the image processing of virtual illumination (S235) being displayed on the simulation screen, determines whether or not an end operation of the arrangement simulation is input, for example (S236).

For example, when the user performs an operation to change various settings in the fields 41 to 43 of the simulation screen, the controller 310 proceeds to NO in step S236, and performs the processing of step S232 and subsequent steps again so as to reflect the changed setting. As a result, every time the user changes the setting, the controller 310 calculates a natural illumination effect in the changed setting and visualizes it to the user as a retouched image in the simulation image field 41, for example (S235).

When the end operation of the arrangement simulation is input (YES in S236), the controller 310 stores image data indicating the retouched image finally obtained by the image processing of virtual illumination (S235) in the memory 320 as a simulation result, for example (S237).

For example, the controller 310 ends the arrangement simulation processing of FIG. 21 by recording the image data of the simulation result (S237).

According to the arrangement simulation processing described above, it is possible to realize a natural illumination effect in the arrangement of the article image Gm1 and the background image Gm2 desired by the user, based on the information obtained by using the illumination device 200 at the time of imaging the article 1 and the background 2 in the present system 20 (S235).

In step S232 described above, an example has been described in which the user selects the background 2 in a state where the article 1 is set in advance in the arrangement simulation processing. The arrangement simulation processing of the present embodiment is not particularly limited thereto. For example, the information terminal 300 may receive a user operation of selecting the article 1 desired to be arranged on the background 2 in a state where the background 2 is set in advance. In addition, a plurality of articles 1 to be arranged on the background 2 may be selectable. For example, the information terminal 300 can perform such arrangement simulation processing in the same manner as described above by storing the model information of each article 1 in the memory 320 in advance.

In step S234 described above, an example has been described in which the user operation for adjusting the illumination parameter of the ambient light is received in the illumination setting field 43. The information terminal 300 of the present system 20 may further receive a user operation for adjusting the light source position of the ambient light. For example, the user may input an illumination fixture desired to be arranged in the room of the background 2, a position and an orientation in which sunlight enters from a window of the room according to a desired time zone, or the like. Set virtual illumination according to such a user input (S234), the information terminal 300 can calculate a natural illumination effect for the virtual illumination desired by the user (S235).

Furthermore, the arrangement simulation processing as described above may be performed by a virtual reality (VR) or augmented reality (AR) technology. For example, alternatively or additionally to the case of FIG. 22, the article 1 and the background 2 may be three-dimensionally displayed. Even in this case, by calculating the illumination effect such as the ambient light using the three-dimensional model information based on the information obtained using the illumination device 200 at the time of imaging with the digital camera 100 in advance (S235), a natural illumination effect can be given to the three-dimensional composite image. For example, in a case where the AR technology is applied, a real background may be used as the background 2.

Furthermore, in the arrangement simulation processing as described above, the illumination device 200 may not be used for both the model information of the article 1 and the model information of the background 2, and the illumination device 200 may be used for just either model information. Even in this case, it is possible to accurately reproduce the reflection characteristics of the subject with respect to the model information using the illumination device 200, and to easily obtain a natural illumination effect.

### 3. Summary

As described above, in the present embodiment, the information terminal 300, which is an example of the image processing apparatus, includes the communication interface 350 as an example of the first and second input interfaces, and the controller 310. The first input interface acquires image data indicating an image of a subject such as an image in which the subject such as the article 1 is captured by the digital camera 100 as an example of the imaging device (S201). The second input interface acquires illuminance distribution data as an example of illuminance distribution information indicating a distribution by illumination light radiated onto a subject from a plurality of light source positions of the illumination device 200 (S202). Based on the acquired image data and illuminance distribution information, the controller 310 generates model information including the captured image of the subject and the characteristic that the subject reflects light such as visible light for each position in the captured image (S207).

According to the information terminal 300 described above, the natural illumination effect in the image of the subject can be easily realized in the virtual illumination system 20 by the model information generated based on the image data of the subject by the digital camera 100 and the illuminance distribution information of the subject by the illumination device 200. The image of the subject is not limited to the captured image of the digital camera 100, and may be an image generated based on the captured image or a CG image. That is, the image data acquired by the first input interface may be data of the CG image.

In the information terminal 300 of the present embodiment, the first input interface acquires a plurality of captured images shot with respect to the subject from different orientations, or image data indicating one captured image (S202, S222). The model information shows an image of a subject based on such a captured image. That is, the image of the subject in the model information is configured with the captured image. For example, the image of the subject may be the captured image itself, an image obtained by performing various image processing on the captured image, or a composite image of the plurality of captured images. By using the actual captured image, the reality of the subject can be improved in the image synthesis simulation. The image of the subject is not necessarily based on the captured image, and may be a CG image.

In the present embodiment, the model information includes the plurality of captured images and characteristics of the subject for each position in each captured image (see S207, FIG. 16). Accordingly, a natural illumination effect can be given to the images of the subject in the plurality of orientations, and the arrangement simulation and the like in the virtual illumination system 20 can be easily performed.

In the information terminal 300 of the present embodiment, the model information includes an image of the subject over at least a part of the entire circumference of the subject such as an all-around image (see S206, S207, FIG. 16). That is, the image of the subject in the model information is an image over at least a part of the entire circumference of the subject. Consequently, a natural illumination effect can be obtained over the entire circumference of the subject or a part thereof in the arrangement simulation of the virtual illumination system 20.

In the information terminal 300 of the present embodiment, the characteristic for the subject to reflect light in the model information includes at least one of the normal direction N of the subject or the reflectance ρ for each position in the captured image (see S204, FIG. 10). The illumination effect can be calculated by reflecting the reflection characteristics of the subject, and a natural illumination effect can be easily realized in the image of the subject.

In the present embodiment, the second input interface acquires illuminance distribution information obtained by the illumination device 200 that individually emits illumination light from a plurality of light source positions different from each other by the first to third illumination light sources 211 to 213, for example. The illuminance distribution information includes a plurality of illuminance distributions in which the reflected light of each illumination light from the plurality of light source positions is received (see FIGS. 9A to 9C). Using such an illumination device 200, a natural illumination effect can be easily realized in the image of the subject.

The information terminal 300 in the present embodiment includes the memory 320, the user interface 330, the controller 310, and the display 340. The memory 320 stores model information including an image of a subject. The user interface 330 receives a user operation related to virtual illumination for the subject (S232 to S234). The controller 310 controls the arrangement simulation processing as an example of the simulation processing of calculating the illumination effect for the model information according to the virtual illumination to be set according to the user operation (S231 to S237). The display 340 displays an effected image which is an image to which the illumination effect is applied by the simulation processing of the controller 310 in the simulation image field 41 (FIG. 22), for example. For example, the model information of the article 1 indicates a reflection characteristic for each position in the image of the article 1 based on illuminance distribution data when the article 1 is irradiated with illumination light from the illumination device 200. The controller 310 performs simulation processing so as to apply an illumination effect to the image of the subject based on the reflection characteristic of the subject indicated by the model information (S235). According to the information terminal 300, it is possible to facilitate to realize a natural illumination effect in the image of the subject in the arrangement simulation or the like of the present system 20 by using the model information.

In the information terminal 300 of the present embodiment, the model information stored in the memory 320 includes model information (first model information) on the article 1 and model information (second model information) on the background 2. At least one of the first and second model information indicates the reflection characteristic of the corresponding subject among the article 1 (object) and the background 2 based on the distribution by the illumination light from the illumination device 200. The user interface 330 receives a user operation (S233) for designating arrangement of the article 1 in the background 2. The controller 310 sets virtual illumination to show ambient light in the background 2 to perform image processing of arrangement simulation (S235). As a result, a natural illumination effect as the ambient light of the background 2 can be given to the article image Gm1.

In the information terminal 300 of the present embodiment, the user interface 330 receives a user operation for adjusting an illumination parameter as an example of a parameter related to virtual illumination (S234). The controller 310 performs image processing so as to apply an illumination effect according to the adjusted illumination parameter to the image of the subject (S235). Accordingly, for the virtual illumination desired by the user, a natural illumination effect can be easily realized in the image of the subject.

In the information terminal 300 of the present embodiment for example, the model information of the article 1 generated by the article imaging operation of FIG. 15 indicates an image of the article 1 over at least a part of the entire circumference of the article 1 based on a plurality of captured images of the article 1 captured from different orientations. In response to a user operation (S233) to change the orientation of the subject on the user interface 330, the controller 310 applies an illumination effect to the image of the article 1 in the changed orientation and causes the display 340 to display the image (S235). Accordingly, it is possible to realize a natural illumination effect on the image of the subject in a plurality of orientations using the model information.

In the information terminal 300 of the present embodiment, the model information indicates a characteristic that the subject reflects light at each position in the captured image based on the distribution by the illumination light radiated onto the subject from the illumination device 200 in the shooting environment of the captured image by the estimation processing of a reflection characteristic, for example (S204). Such model information makes it easy to realize a natural illumination effect in the image of the subject.

In the present embodiment, the virtual illumination system 20 includes the digital camera 100 that images a subject and generates image data, the illumination device 200 that irradiates the subject with illumination light and acquires information indicating a distribution by the illumination light, and the information terminal 300. According to the present system 20, it is possible to easily realize a natural illumination effect in the image of the subject by using the information acquired by the digital camera 100 and the illumination device 200 in the information terminal 300.

### Third Embodiment

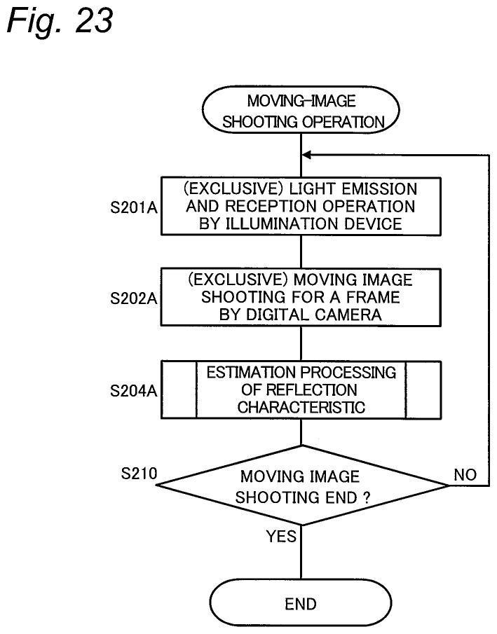

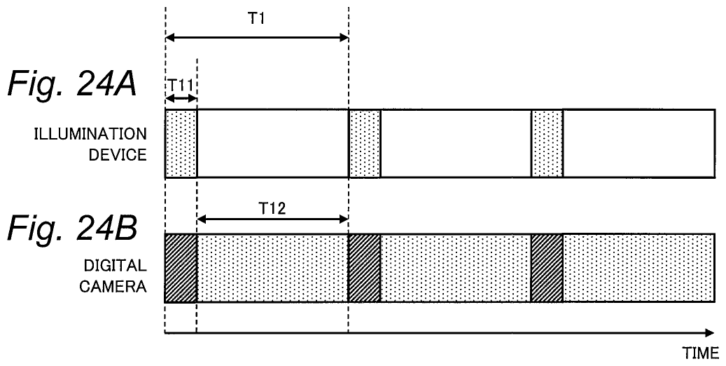

Hereinafter, a third embodiment of the present disclosure will be described with reference to FIGS. 23 to 24. In the second embodiment, the example in which the virtual illumination system 20 is applied to the arrangement simulation has been described. In the third embodiment, an example in which a virtual illumination system is applied to an application of video production will be described.

Hereinafter, description of configurations and operations similar to those of the systems 10 and 20 according to the first and second embodiments will be omitted as appropriate, and a virtual illumination system according to the present embodiment will be described.

FIG. 23 is a flowchart illustrating an operation of the virtual illumination system according to the third embodiment. For example, the processing illustrated in the flowchart of FIG. 23 starts when capturing of a moving image is instructed by a user operation.

In the present embodiment, an exemplary application of the virtual illumination system is that a user such as a creator creates a video work such as a moving image in a desired production. The present system 20 enables the information terminal 300 or the like to apply an illumination effect afterwards by using the illumination device 200 at the time of capturing a moving image by the digital camera 100. According to the present system, it is possible to realize video production with a high degree of freedom such that a desired illumination effect can be edited in post-processing, without the need to prepare particularly difficult illumination equipment.

In the moving-image shooting operation (FIG. 23) in the present system, the controller 310 transmits a control signal to cause the illumination device 200 to execute light emission and reception operation for each type of illumination light, for example (S201A). For example, the controller 310 transmits a control signal to cause the digital camera 100 to execute an imaging operation for each frame of a moving image (S202A).

In steps S201A and S202A of the present embodiment, the controller 310 generates each control signal so as to exclusively operate the illumination device 200 and the digital camera 100 in processing similar to steps S201 and S202 of the second embodiment (FIG. 15), for example. Such exclusive control will be described later (see FIGS. 24A and 24B).

Furthermore, the controller 310 performs the estimation processing of a reflection characteristic for each frame imaged by the digital camera 100, for example (S204A). The processing of step S204A is performed similarly to the estimation processing of a reflection characteristic (S204 of FIG. 15) of the second embodiment based on the illuminance distribution data acquired by the illumination device 200 in a predetermined number of frames before the present time.

For example, when the instruction to end capturing of the moving image is not given (NO in S210), the controller 310 repeats the processing of step S201A and subsequent steps. For example, when the instruction to end shooting of the moving image is input by a user operation (YES in S210), the controller 310 stores the captured moving image data and the reflectance estimation information for each frame in the memory 240 or the like in association with each other as appropriate, to end the processing illustrated in the flow of FIG. 23.

According to the above processing, the illuminance distribution data that changes from moment to moment according to the movement of the camerawork or the subject in the moving image to be shot can be acquired by operating the illumination device 200 simultaneously with the capturing of the moving image by the digital camera 100. At this time, there would be a problem that light emission for acquiring illuminance distribution data appears in the moving image data to cause an unnatural illumination effect or the like. In the present system, exclusive control for solving such a new problem will be described with reference to FIGS. 24A and 24B.

FIGS. 24A and 24B are timing charts for explaining an operation example of exclusive control in the present system. FIG. 24A illustrates a light emission timing of the illumination device 200. FIG. 24B illustrates an exposure timing of the digital camera 100.

In the example of FIGS. 24A and 24B, an exposure mask period T11 and an exposure period T12 are provided during a frame period T1 of a moving image. For example, the exposure mask period T11 corresponds to step S201A, and the exposure period T12 corresponds to step S202A. For example, when the exposure mask period T11 is set to 3 milliseconds with respect to the frame period T1 of 1/60 seconds, the exposure period T12 can be secured to about 14 milliseconds. Note that the periods T1, T11, and T12 are not limited to the above, and can be set as appropriate.

In the present operation example as illustrated in FIG. 24A, the illumination device 200 performs an operation of emitting and receiving illumination light during the exposure mask period T11 in the frame period T1, for example (S201A). During the subsequent exposure period T12, the illumination device 200 stops emitting the illumination light, and generates the illuminance distribution data based on the light reception result during the exposure mask period T11.

For example, the illumination device 200 performs one type of light emission among light emission of respective colors in the first to third illumination light sources 211 to 213 per exposure mask period T11 (S201A). The illumination device 200 may perform a plurality of types of light emission and reception during the exposure mask period T11. For example, in the above operation example, the illumination device 200 may perform all types of light emission and reception at an initial stage of capturing of the moving image.

On the other hand, as illustrated in FIG. 24B, the digital camera 100 does not expose the image sensor 115 during the exposure mask period T11 in which the illumination light is emitted in the frame period T1, but exposes the image sensor 115 during the exposure period T12 in which the emission of the illumination light is stopped, for example (S202A).

As described above, by exclusively controlling the exposure in the capturing of the moving image of the digital camera 100 and the light emission of the illumination device 200, the present system can acquire the illuminance distribution data during the capturing of the moving image, and can suppress a situation in which light emission for obtaining the illuminance distribution data affects the moving image. Therefore, it can facilitate to realize a natural illumination effect for a captured image of a subject or the like moving in a moving image.

As described above, the information terminal 300 as an example of the image processing apparatus in the present embodiment includes the communication interface 350 as an example of an input interface that acquires image data indicating an image in which a subject is imaged by the digital camera 100 and illuminance distribution information indicating distribution by illumination light radiated onto the subject from the illumination device 200, and the controller 310 that controls the digital camera 100 and the illumination device 200. The digital camera 100 sequentially captures subject images at a predetermined cycle to generate image data. The controller 310 causes the illumination device 200 to irradiate the subject with the illumination light when the digital camera 100 is not imaging the subject (i.e. not capturing the subject image) in a predetermined cycle, and causes the digital camera 100 to image the subject when the illumination device 200 is not irradiating the subject with the illumination light (see S201A, S202A, FIGS. 24A and 24B).

Even with such an image processing apparatus, it is possible to facilitate to realize a natural illumination effect in the image of the subject in the virtual illumination system. Furthermore, such an image processing apparatus may acquire either image data or illuminance distribution information. For example, the digital camera 100 or the illumination device 200 may be an example of the image processing apparatus.

### Other Embodiments

As described above, the first to third embodiments have been described as an example of the technique disclosed in the present application. However, the technology in the present disclosure is not limited to this, and is applicable to embodiments in which changes, replacements, additions, omissions, and the like are appropriately made. Further, each component described in the first embodiment can be combined to make a new embodiment.

In the first embodiment described above, the configuration example of the illumination device 200 in which the light emitter 210 includes the plurality of illumination light sources 21 has been described. In the present embodiment, the light emitter 210 of the illumination device 200 may not include the plurality of illumination light sources 21, and may be configured to radiate illumination light from a plurality of light source positions by one illumination light source 21, for example. For example, the light emitter 210 of the illumination device 200 may have a structure such as a slit capable of changing the light source position. Such an illumination device 200 can also obtain illuminance distribution data corresponding to illumination light from a plurality of light source positions, and can be applied to image processing (S4) of virtual illumination of the present system 10 and the like.

In the first embodiment described above, the video editing PC 300 has been exemplified as an example of the image processing apparatus. In the present embodiment, the image processing apparatus is not particularly limited to the video editing PC 300, and may be various information processing apparatuses such as a tablet terminal or a smartphone. Furthermore, the digital camera 100 may have the function of an image processing apparatus by the controller 135 or the like. In this case, the digital camera 100 is an example of an imaging system, and the image sensor 115 may function as an example of an imaging device in the system.

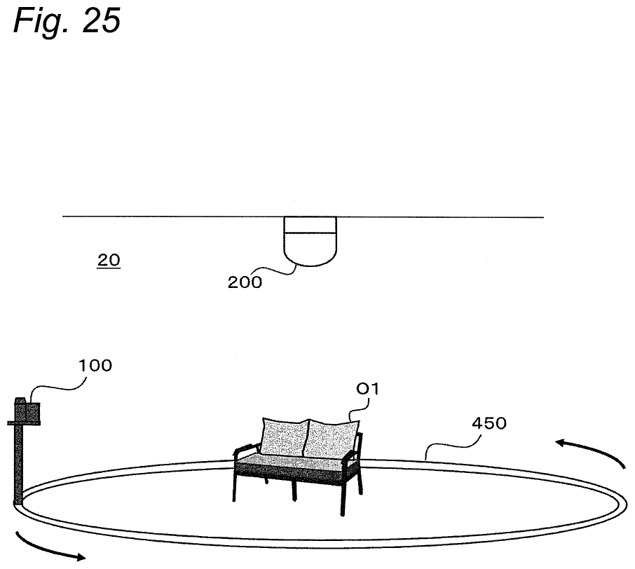

In the second embodiment described above, the article imaging operation using the rotation table 400 has been described, but the article imaging operation may be performed without using the rotation table 400. Such a modification will be described with reference to FIG. 25.

FIG. 25 illustrates an environment of first modification of the article imaging operation. In the present modification, instead of the rotation table 400, a rail 450 surrounding the periphery of the article 1 is disposed on the same plane such as a horizontal plane. The rail 450 is configured to be slidable on a support portion of the digital camera 100. In the present modification, in the same operation as in FIG. 15, instead of rotating the article 1 by the rotation table 400, a moving image or the like is captured while rotating the digital camera 100 over the entire periphery of the article 1 along the rail 450. As a result, the captured image over the entire circumference of the article 1 can be acquired, and the model information of the article 1 can be created similarly to the above example.

In addition, the article imaging operation as described above may be performed by a creator using the digital camera 100 performing imaging while moving around the article 1 instead of using the rail 450. In the article imaging operation, a plurality of illumination devices 200 may be used. For example, the plurality of illumination devices 200 may be arranged around the article 1.

In the above embodiments, the article imaging operation over the entire circumference of the article 1 has been described, but the entire circumference of the article 1 may not be particularly required. For example, the digital camera 100 may capture a moving image of a part of the entire circumference of the article 1, or may capture still images or the like a plurality of times from different orientations with respect to the article 1. As a result, the model information can be obtained for the plurality of captured images in which the article 1 is captured from orientations different from each other, and can be used for the arrangement simulation.

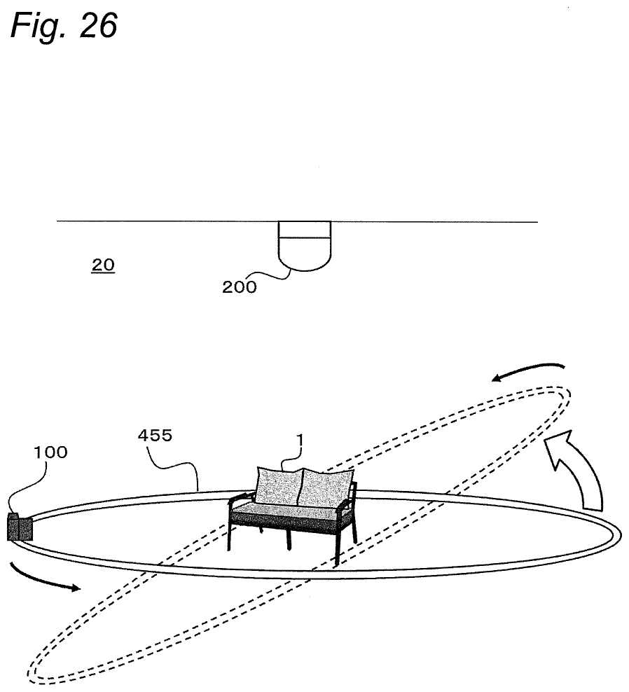

In addition, the entire circumference of the article 1 or a part thereof in the above-described article imaging operation is not particularly limited to the same plane, and may be three-dimensional. Such a modification will be described with reference to FIG. 26.

FIG. 26 is a diagram for describing second modification of the article imaging operation. In the present modification, instead of the rail 450 of the above modification, a slider 455 is used in which the digital camera 100 can three-dimensionally slide around the article 1. For example, in addition to the same configuration as the rail 450 the slider 455 has a rotation shaft capable of stereoscopically rotating in a range in which the digital camera 100 slides out of a horizontal plane or the like. In the present embodiment, in the article imaging operation (FIG. 15) of the digital camera 100 for example, a desired range may be imaged in the entire circumference of the article 1 on the entire spherical surface or the hemispherical surface by such a slider 455. As a result, the three-dimensional modeling in the model information (S207 in FIG. 15) of the article 1 can be made highly accurate. Thus, the degree of freedom in the direction (see FIG. 22) in which the orientation of the article 1 can be changed when the user browses the article 1 in the arrangement simulation or the like can be improved.

In the above embodiments, an example of the model information of the article 1 or the like has been described, but the model information is not limited thereto. In the virtual illumination system 20 of the present embodiment, the model information may be information in which image data obtained by imaging the subject by the digital camera 100 and illuminance distribution data of the subject by the illumination device 200 are associated with each other. For example, in processing similar to the flow of FIG. 15, the controller 310 of the information terminal 300 may not particularly perform the processing of step S204 and may generate the model information by the association instead of step S207. Based on such model information, at the time of execution of the arrangement simulation processing (FIG. 21), processing similar to that in step S204 may be performed, for example.

In the above embodiments, an example has been described in which various information processing of the virtual illumination system 20 are performed by the information terminal 300. The present system 20 is not particularly limited thereto, and a server device that performs data communication with the information terminal 300 may be further used, for example. For example, the calculation processing (S235) of the virtual illumination in the arrangement simulation processing (FIG. 21) may be performed by the server device. The information terminal 300 may transmit the information obtained in steps S232 to S234 to such a server device and receive the processing result of step S235 from the server device. Also in various imaging operations, part or all of the estimation processing of a reflection characteristic (S204, S223) and the generation of various model information (S207, S224) may be performed by the server device.

In the above embodiments, the virtual illumination system 20 that performs the arrangement simulation processing of the article 1 on the background 2 has been described. In the present embodiment, the virtual illumination system 20 may perform calculation processing for virtual illumination not particularly limited to the arrangement simulation. For example, the virtual illumination system 20 of the present embodiment may perform simulation processing of virtual illumination for the user to check the appearance of the article 1. Even in such a case, it may be difficult to reproduce appearance such as color tone or texture of the actual article 1 during simulation.

To address this, according to the virtual illumination system 20 of the present embodiment, it is possible to realize a natural illumination effect and improve the reproducibility of the appearance of the article 1 by using the information obtained by the illumination device 200 at the time of imaging the article 1 in the same manner as in the above embodiment. For example, in the virtual illumination system 20 of the present embodiment, the controller 310 can perform the simulation processing of the present embodiment by omitting display of the background image Gm2 and the like in processing similar to that in FIG. 21.

In addition, the virtual illumination system 20 of the present embodiment may be used not only for the simulation processing of only the article 1 but also for the simulation processing of only the background 2. For example, the real estate property as the background 2 may be imaged using the illumination device 200, and the present system 20 may perform virtual simulation processing of the inside view using the model information thus obtained.

In the above embodiments, the virtual illumination system 20 including the digital camera 100, the illumination device 200, and the information terminal 300 has been described, but the virtual illumination system 20 of the present embodiment is not limited thereto. For example, in the virtual illumination system 20 of the present embodiment, the digital camera 100 may be omitted. For example, an image of a subject may be captured or acquired by using an image sensor or the like as the light receiver 220 of the illumination device 200. In the present system 20, the illumination device 200 and the imaging device may be integrally configured. Furthermore, the image of the subject may be acquired from outside the present system 20.

In the above embodiments, the information terminal 300 has been exemplified as an example of the image processing apparatus. In the present embodiment, the image processing apparatus is not particularly limited to the information terminal 300, and may be a server device, for example. Furthermore, the digital camera 100 may have the function of an image processing apparatus by the controller 135 or the like; In this case, the image sensor 115 of the digital camera 100 may function as an example of the imaging device.

Furthermore, the exclusive control in the third embodiment may be used at the time of image shooting for generating the model information as in the second embodiment. That is, in the present embodiment, the controller in the image processing apparatus similar to the second embodiment may control an imaging device that sequentially captures a subject image at a predetermined cycle to generate the image data, and control an illumination device, and wherein, in the predetermined cycle, the controller may cause the illumination device to irradiate the subject with the illumination light when the imaging device does not capture the subject image, and cause the imaging device to capture the subject image when the illumination device does not irradiate the subject with the illumination light.

In the above embodiments, the digital camera 100 including the optical system 110 and the lens driver 112 has been exemplified. The imaging device of the present embodiment may not include the optical system 110 and the lens driver 112, and may be an interchangeable lens type camera, for example.

In the above embodiments, the digital camera has been described as an example of the imaging device (and the imaging system), but the present disclosure is not limited thereto. The imaging device (and the imaging system) of the present disclosure may be an electronic device (e.g., a video camera, a smartphone, a tablet terminal, or the like) having an image capturing function.

As described above, the embodiments have been described as an example of the technology in the present disclosure. For this purpose, the accompanying drawings and the detailed description have been provided.

Accordingly, some of the components described in the accompanying drawings and the detailed description may include not only essential components for solving the problem but also components which are not essential for solving the problem in order to describe the above technology. Therefore, it should not be immediately recognized that these non-essential components are essential based on the fact that these non-essential components are described in the accompanying drawings and the detailed description.

Further, the above-described embodiments are provided to illustrate the technique in the present disclosure, and hence it is possible to make various changes, replacements, additions, omissions, and the like within the scope of claims or the equivalent thereof.

The present disclosure is applicable to an application of applying an illumination effect to an image shot in various shooting environments afterwards, and is applicable to a video production application, for example.

1. An image processing apparatus comprising:
a first input interface that acquires first image data indicating an original image shot with an imaging device with respect to a subject in a shooting environment;
a second input interface that acquires illuminance distribution information indicating a distribution based on illumination light radiated onto the subject from an illumination device in the shooting environment;
a user interface that receives a user operation to set virtual illumination; and
a controller that generates second image data by retouching the first image data to apply an illumination effect onto the original image with reference to the illuminance distribution information, the illumination effect corresponding to the virtual illumination set by the user operation.

2. The image processing apparatus according to claim 1,
wherein the illumination device emits the illumination light respectively from a plurality of light source positions that are different from each other,
the illuminance distribution information includes a plurality of illuminance distributions each obtained by receiving reflected light of each illumination light from the plurality of light source positions, and
the controller applies the illumination effect of the virtual illumination to the original image, based on a difference between the plurality of illuminance distributions in the illuminance distribution information.

3. The image processing apparatus according to claim 2,
wherein the illumination device includes a light receiver having a light receiving surface to receive reflected light for each illumination light radiated from the plurality of light source positions, and
wherein the illuminance distribution information indicates, as the plurality of illuminance distributions, results of receiving the reflected light for each illumination light from the plurality of light source positions on the light receiving' surface by the light receiver.

4. The image processing apparatus according to claim 2,
wherein the controller
calculates a normal direction and a reflectance of the subject, based on the difference between the plurality of illuminance distributions in the illuminance distribution information; and
applies the illumination effect of the virtual illumination to the original image, based on a calculation result of the normal direction and the reflectance of the subject.

5. The image processing apparatus according to claim 1,
further comprising a display that displays environment information indicating the shooting environment,
wherein the user interface receives a user operation to set arrangement of the virtual illumination in the shooting environment in the environment information displayed on the display.

6. The image processing apparatus according to claim 5, wherein the environment information indicates the shooting environment in a wider range than a corresponding range to the original image.

7. The image processing apparatus according to claim 1,
wherein the imaging device sequentially captures a subject image at a predetermined cycle, and
wherein, in the predetermined cycle, the controller
causes the illumination device to irradiate the subject with the illumination light when the imaging device does not capture the subject image, and
causes the imaging device to image the subject when the illumination device does not irradiate the subject with the illumination light.

8. A virtual illumination system comprising:
an imaging device that captures an image of a subject to generate the first image data; and
the image processing apparatus according to claim 1,
wherein the image processing apparatus generates the second image data by retouching the first image data generated by the imaging device, to apply the illumination effect to the original image indicated by the first image data.

9. A virtual illumination system comprising:
the image processing apparatus according to claim 1; and
an illumination device that irradiates the shooting environment of the subject with the illumination light to generate the illuminance distribution information for image processing to retouch the original image shot in advance,
wherein the illumination device includes:
a light emitter that emits the illumination light respectively from a plurality of light source positions that are different from each other; and
a light receiver that receives reflected light for each illumination light radiated from the plurality of light source positions, to generate the illuminance distribution information including the distribution of the illumination light radiated onto the subject.

10. An image processing apparatus comprising:
a first input interface that acquires image data indicating an image of a subject;
a second input interface that acquires illuminance distribution information indicating a distribution based on illumination light radiated onto the subject from a plurality of light source positions; and
a controller that generates model information, based on the acquired image data and the acquired illuminance distribution information, the model information including the image of the subject and a characteristic for the subject to reflect light for each position in the image.

11. The image processing apparatus according to claim 10,
wherein the first input interface acquires image data indicating one or more captured images shot with respect to the subject, and
wherein the image of the subject in the model information is configured with the one or more captured images.

12. The image processing apparatus according to claim 10, wherein the image of the subject is an image over at least a part of an all-around image of the subject.

13. The image processing apparatus according to claim 10, wherein the characteristic for the subject to reflect light includes at least one of a normal direction of the subject or a reflectance for each position in the image.

14. The image processing apparatus according to claim 10,
wherein the second input interface acquires the illuminance distribution information obtained by an illumination device that emits the illumination light respectively from a plurality of light source positions that are different from each other, and
wherein the illuminance distribution information includes a plurality of illuminance distributions each obtained by receiving reflected light of each illumination light from the plurality of light source positions.

15. An image processing apparatus comprising:
a memory that stores model information including an image of a subject;
a user interface that receives a user operation with respect to virtual illumination for the subject;
a controller that controls simulation processing according to the user operation, the simulation processing calculating an illumination effect for the model information according to the virtual illumination to be set; and
a display that displays an effected image to which the illumination effect is applied by the simulation processing,
wherein the model information indicates a characteristic for the subject to reflect light for each position in the image of the subject, based on a distribution by illumination light radiated onto the subject from a plurality of light source positions, and
wherein the controller performs the simulation processing to apply the illumination effect to the image of the subject, based on the characteristic of the subject indicated by the model information.

16. The image processing apparatus according to claim 15,
wherein the model information includes first model information indicating an object as the subject and second model information indicating a background as the subject,
wherein at least one of the first or second model information indicates a characteristic of a corresponding subject among the object and the background, based on a distribution by the illumination light,
wherein the user interface receives a user operation for designating arrangement of the object in the background, and
wherein the controller sets the virtual illumination to show ambient light in the background to perform the simulation processing.

17. The image processing apparatus according to claim 15,
wherein the model information indicates an image of the subject over at least a part of an all-around image of the subject, and
wherein according to a user operation to change an orientation of the subject on the user interface, the controller applies the illumination effect to the image of the subject in a changed orientation of the subject to display the effected image on the display.

18. The image processing apparatus according to claim 10,
wherein the controller controls an imaging device that sequentially captures a subject image at a predetermined cycle to generate the image data, and controls an illumination device, and
wherein, in the predetermined cycle, the controller
causes the illumination device to irradiate the subject with the illumination light when the imaging device does not capture the subject image, and
causes the imaging device to capture the subject image when the illumination device does not irradiate the subject with the illumination light.

19. A virtual illumination system comprising:
an illumination device that irradiates the subject with illumination light to acquire information indicating a distribution based on the illumination light; and
the image processing apparatus according to claim 10.
